(19) United States
(12) Patent Application Publication
(10) Pub. No.: US 2017/0047159 A1
(43) Pub. Date: Feb. 16, 2017

(54) TRANSFORMER AND POWER SOURCE DEVICE

(71) Applicant: SHARP KABUSHIKI KAISHA, Sakai City, Osaka (JP)

(72) Inventors: Hiroshi ITOH, Sakai City (JP); Hironobu SHITAMURA, Sakai City (JP)

(73) Assignee: SHARP KABUSHIKI KAISHA, Sakai City, Osaka (JP)

(21) Appl. No.: 15/118,593

(22) PCT Filed: Feb. 18, 2015
(86) PCT No.: PCT/JP2015/054494

§ 371 Date: Aug. 12, 2016

(30) Foreign Application Priority Data
Mar. 14, 2014 (JP) 2014-052580

(51) Int. Cl. H01F 27/29; H01F 27/24; H01F 27/32; H01F 27/02; H01F 27/28; H01F 27/30

(52) U.S. Cl. CPC H01F 27/292; H01F 27/2828; H01F 27/306; H01F 27/325; H01F 27/02; H01F 27/24; H01F 2027/297

(57) ABSTRACT

Opening portions (5a and 6a) through which a base (2c) extends to an outside of one side of a core part which is formed by stacking a first core (5) and a second core (6) are formed in the first core (5) and the second core (6) in a transformer (1), and, in the base (2c), a portion which is closer to one region of an exposed core portion A (first region) and an exposed core portion B (second region) is notched, so that the transformer which secures an insulation property and is capable of realizing further size reduction is provided.

### TECHNICAL FIELD

The present invention relates to a transformer and a power source device including the transformer.

### BACKGROUND ART

A transformer (insulating transformer) is generally included in a power source device such as an AC adaptor, and such a power source device generally has a function of converting a predetermined AC voltage (whose virtual value (RSM) is 100 V in Japan) into a desired DC voltage (for example, a direct-current voltage (DC) of 19 V for a notebook PC).

Moreover, such a power source device also has a function of insulating electronic equipment (a notebook PC, a TV, or the like) from a power transmission and distribution supply (a wall outlet or the like).

One line of the power transmission and distribution supply is connected to the earth (ground), and AC 100 V is supplied to another line. In a case where power is supplied to electronic equipment without using an insulating transformer (hereinafter, referred to as a transformer), when a person accidently touches a line to which AC 100 V is supplied or any other high voltage line, a current loop is generated in which current flows to the ground via the person, and an electric shock accident occurs.

In order to avoid such a problem, power is supplied to electronic equipment via a transformer, and, in the transformer, a primary side connected to a power transmission and distribution side and a secondary side connected to an electronic equipment side are not electrically connected in a direct manner, and are insulated. Here, there are different types of insulation, such as reinforced insulation and functional insulation, in accordance with use, and the insulation between the primary side and the secondary side in this case is reinforced insulation. For example, a ground line of the secondary side and a power line of +24 V are insulated from each other. For example, an interval between lines of both patterns is secured for about 2 mm, and this insulation corresponds to functional insulation, and is different from reinforced insulation which affects the human body and which will be important at the time of explanation of the present application. In the present application, the reinforced insulation is the insulation described below.

As above, in the case where power is supplied to electronic equipment via a transformer, there is no risk of electric shock, so that it is possible to safely use the electronic equipment.

Here, the transformer includes: a core made of a magnetic material for securing a path through which magnetic flux passes; a primary winding through which an electric current of the primary side flows; a secondary winding through which an electric current of the secondary side flows; a bobbin which has a winding drum in order to arrange the respective windings of the primary side and the secondary side so as to join them to each other; and terminals which are attached to the bobbin for connection of the respective windings of the primary side and the secondary side. It is necessary to safely secure an insulation distance between the primary-side terminal and the secondary-side terminal, and, since the core is a semiconductor which is also electrically conductive, it is necessary to provide insulation between the core and the terminals. It is necessary to provide an insulation distance between the primary-side terminal and the core and between the core and the secondary-side terminal. When the core is regarded as having a primary-side potential, insulation is required only between the core and the secondary-side terminal. When the core is regarded as having a secondary-side potential, insulation is required only between the primary-side terminal and the core.

On the other hand, in the field of power source devices, there is a strong demand for size reduction. For example, as for an AC adaptor for a notebook PC or the like, further size reduction is required in terms of portability. Moreover, as for a power source embedded in a TV, in order to make the TV thinner, it is necessary to reduce an area occupied by the power source, and therefore further size reduction is required.

As one example of a miniaturized transformer, a transformer using ferrite cores, which is disclosed in PTL 1 below, may be cited.

FIG. 16 is a view illustrating a schematic configuration of a conventional transformer which uses ferrite cores, in which FIG. 16(a) is a side view viewed from a portion in which primary-side terminals are formed and FIG. 16(b) is a side view viewed from a portion in which secondary-side terminals are formed.

As illustrated, a ferrite core 101 is an E-type core in which outer legs 103 are formed so as to protrude from both ends of a surface of one side of an end plate part 102 and a center leg 104 is formed so as to protrude from the center.

Moreover, the transformer is a longitudinal type in which, among flange parts 108 and 109 formed at both ends of a winding drum part 106 on a bobbin 105, around which windings 110 are wound, a terminal block 111 to which primary-side terminals 113 are attached and a terminal block 112 to which secondary-side terminals 114 are attached are provided only in the flange part 108.

The windings 110 around the outer periphery of which a tape is wound includes a primary winding and a secondary winding. The respective center legs 104 of a pair of ferrite cores 101 and 101 are separately inserted into the hollow winding drum part 106 of the bobbin 105, around which the windings 110 are wound, from an upper side and a lower side, and the respective outer legs 103 and 103 are arranged between the terminal block 111 and the terminal block 112 so that the pair of ferrite cores 101 and 101 is combined with the bobbin 105.

According to such a conventional configuration, it is possible to realize size reduction to a certain degree by devising a layout of components or the like.

### CITATION LIST

### Patent Literature

PTL 1: Japanese Unexamined Patent Application Publication No. 2007-96123 (published on Apr. 12, 2007)

### SUMMARY OF INVENTION

### Technical Problem

However, since there is no technical concept for realizing further size reduction in the conventional transformer using the ferrite cores, which is disclosed in PTL 1 above, the respective primary-side terminals 113 are formed in line symmetry with respect to a straight line which is drawn in a direction from the primary-side terminals 113 to the secondary-side terminals 114 so as to divide the hollow winding drum part 106 of the bobbin 105 into two equal parts, as illustrated in FIG. 16(a). In addition, the respective secondary-side terminals 114 are also formed in line symmetry with respect to the straight line which is drawn in the direction from the primary-side terminals 113 to the secondary-side terminals 114 so as to divide the hollow winding drum part 106 of the bobbin 105 into two equal parts, as illustrated in FIG. 16(b).

Due to such a configuration, the terminal block 111 to which the primary-side terminals 113 are attached and the terminal block 112 to which the secondary-side terminals 114 are attached are also to be formed in line symmetry with respect to the straight line which is drawn in the direction from the primary-side terminals 113 to the secondary-side terminals 114 so as to divide the hollow winding drum part 106 of the bobbin 105 into two equal parts.

As above, in the conventional transformer using the ferrite cores, which is disclosed in PTL 1 above, due to influence of shapes of the terminal block 111 and the terminal block 112, it is difficult to realize further size reduction of the transformer and further size reduction of a power source device including the transformer.

Further, in the conventional transformer using the ferrite cores, which is disclosed in PTL 1 above, an exposed core portion is necessarily generated in the ferrite core, and a size of the terminal block 111 or the terminal block 112 is increased in order to secure an insulation distance between the exposed core portion and the primary-side terminals 113 or the secondary-side terminals 114, so that it is difficult to miniaturize the transformer itself.

Description will be given below by taking, as examples, still other transformers and adaptors each including a transformer, which have a similar problem and have been proposed conventionally.

Since there is no technical concept for reducing size of a transformer and an adaptor including a transformer, in order to secure a predetermined insulation distance from each exposed core portion to each terminal part (specifically, a creepage distance on a base, which will be described below), a shape of the base part of each of conventional transformers and conventional adaptors each including a transformer, which are illustrated in FIG. 17 to FIG. 23, is a symmetric type which has high versatility.

FIG. 17 is a view illustrating a schematic configuration of a conventional transformer provided with a bobbin body in which a hollow winding drum part (the hollow winding drum part is to include a base supporting a hollow winding drum) and a base part in which terminal parts are formed are integrated and PQ-type cores. The PQ type here is a name of a specific manufacturer manufacturing the core. In the above-described E-type core, lateral widths of the end plate part 102 and the outer legs 103 are the same, but the PQ core has the end plate part 102 spreading from the center thereof so as to be in a fan shape, and has a shape with which magnetic flux is able to be used effectively compared with the E-type one.

FIG. 17(a) illustrates a plan view of a transformer 201, which is viewed from above, FIG. 17(b) illustrates a perspective view of the transformer 201, FIG. 17(c) illustrates a side view of the transformer 201, and FIG. 17(d) illustrates a plan view of the transformer 201 which is set so that a second core 206 is positioned in an upper side, which is viewed from above.

As illustrated in FIG. 17(a), the conventional transformer 201 is provided with a bobbin body 202. In the bobbin body 202, a hollow winding drum part 202a and a base part 202b in which terminal parts 203 are provided are integrated.

Note that, the hollow winding drum part 202a and the base part 202b are made of insulating resin.

The hollow winding drum part 202a is wound with windings 204 serving as a primary winding and a secondary winding, which are formed of copper wires, for example, and, in this case, the primary winding and the secondary winding are electrically insulated by an insulating member.

As illustrated in FIG. 17(b) and FIG. 17(c), by separately inserting protrusions in the centers of a first core 205 and a second core 206 which are PQ-type cores into a hollow portion of the winding drum part 202a from up and down directions, and stacking protrusions in respective end parts of the first core 205 and the second core 206 with each other for fixation, the transformer 201 in which the bobbin body 202 and the first core 205 and the second core 206 are combined is obtained.

The first core 205 and the second core 206 are respectively provided with opening portions 205a and 206a through which the base part 202b formed integrally with the hollow winding drum part 202a extends to an outside of a core part composed of the first core 205 and the second core 206.

Note that, the first core 205 and the second core 206 are formed of a ferrite material, and such a ferrite material is able to be obtained by firing a mixture of, for example, nickel, manganese, zinc, or the like and iron oxide. Since the ferrite material has semiconductor characteristics, it is necessary to secure a predetermined insulation distance between the first core 205 and the second core 206 which are made of the ferrite material and each conductive body such as a body of a component, a pattern of a printed-circuit board, or the terminal parts 203.

With a countermeasure such as winding an insulating tape around the outer sides of the first core 205 and the second core 206, it is possible to shorten the predetermined insulation distance. The insulation distance is required to be a distance prescribed by a safety standard as for each of a clearance and a creepage distance. The countermeasure such as winding a tape is an effective countermeasure particularly against the clearance. However, as illustrated in FIG. 17(b), it is difficult to wind the insulating tape due to shapes of the first core 205 and the second core 206, so that exposed core portions are generated. Based on the exposed portions, a discharge path of creepage which goes along the base part and reaches the terminals (surface along a surface of an insulating body) is generated.

The exposed core portions are generated at least at positions at both ends of the above-described opening portions 205a and 206a through which the base part 202b formed integrally with the hollow winding drum part 202a extends to the outside of the core part composed of the first core 205 and the second core 206 and at a substantially same height as the base part 202b.

As above, the first core 205 and the second core 206 in the transformer provided with the bobbin body in which the hollow winding drum part and the base part in which the terminal parts are formed are integrated are required to include the opening portions through which the base part 202b formed integrally with the hollow winding drum part 202a extends to the outside of the core part composed of the first core 205 and the second core 206, so that, due to the structures thereof, the exposed core portions are generated.

The shape of the base part is formed in line symmetry with respect to a line which passes through the centers of lines each connecting the exposed core portions positioned at both ends of the base part and is orthogonal to the lines each connecting the exposed core portions.

Specifically, as illustrated in FIG. 17(d), sites indicated with dotted-line circles in the drawing are an exposed core portion A to an exposed core portion D, and the base part 202b formed integrally with the hollow winding drum part 202a is formed in line symmetry with respect to a dotted line E-F in the drawing.

Since the base part 202b has such a shape, it is possible to set a distance from the exposed core portion A in an upper side of the drawing to the closest terminal part 203a as an insulation distance C (for example, 7 mm), while it is also possible to set a distance from the exposed core portion B in a lower side of the drawing to the closest terminal part 203a as an insulation distance D (for example, 7 mm).

Conventionally, in order to secure the insulation distances in this manner, the base part 202b having the shape in line symmetry with respect to the dotted line E-F in the drawing, which passes through the center of a line connecting the exposed core portion A and the exposed core portion B and is orthogonal to the line connecting the exposed core portion A and the exposed core portion B, is provided, and the terminal parts 203a are provided in an end part of the base part 202b, which is farther from the first core 205 and the second core 206. That is, insulation characteristics of the transformer 201 are secured by providing all of the terminal parts 203a at positions distant from a dotted line A-B in FIG. 17(d) by a fixed distance in a direction of a region b.

Note that, for the transformer 201 in the drawing, it is assumed that a voltage input from an input side (primary side) is converted into a predetermined voltage, and thereafter output from the terminal parts 203a in an output side (secondary side). When it is assumed that the core part composed of the first core 205 and the second core 206 has a primary-side potential, in terms of the necessary safety standard, it is necessary to secure a predetermined insulation distance from the exposed core portion A and the exposed core portion B for the terminal parts 203a, but it is not necessary to secure the predetermined insulation distance from the exposed core portion C or the exposed core portion D for terminal parts (not illustrated) in the input side (primary side).

On the other hand, in a case where the terminal parts 203a are set as the terminal parts in the input side (primary side) and the core part composed of the first core 205 and the second core 206 has a secondary-side potential, it is necessary to secure the predetermined insulation distance from the exposed core portion A and the exposed core portion B for the terminal parts 203a, but in terms of the necessary safety standard, it is not necessary to secure the predetermined insulation distance from the exposed core portion C or the exposed core portion D for terminal parts (not illustrated) in the output side (secondary side).

Note that, in a case where it is necessary to secure the predetermined insulation distance from the exposed core portion C and the exposed core portion D, it is possible to secure insulation characteristics by providing all of the terminal parts at positions distant from the dotted line A-B in the drawing by the fixed distance in a direction of a region a.

As above, in the conventional transformer 201, a size of the base part 202b included in the bobbin body 202 is increased in order to secure the insulation characteristics thereof, so that it is difficult to realize further size reduction of the transformer and further size reduction of a power source device including the transformer.

FIG. 18 is a view illustrating a schematic configuration of another conventional transformer provided with a bobbin body in which a hollow winding drum part (the hollow winding drum part is to include a base supporting a hollow winding drum) and a base part in which terminal parts are formed are integrated and PQ-type cores.

FIG. 18(a) illustrates a plan view of a transformer 301, which is viewed from above, FIG. 18(b) illustrates a perspective view of the transformer 301, FIG. 18(c) illustrates a side view of the transformer 301, and FIG. 18(d) illustrates a plan view of the transformer 301 which is set so that a second core 306 is positioned in an upper side, which is viewed from above.

Note that, the transformer 301 illustrated in FIG. 18 is different from the above-described transformer 201 illustrated in FIG. 17 only in terms of the shapes of base parts included in a bobbin body, so that description will be given here only for the shapes of the base parts and description of other members will be omitted.

As illustrated in FIG. 18(a), in a bobbin body 302, a hollow winding drum part 302a, a base part 302b in which terminal parts 303a are provided, and a base part 302c in which terminal parts 303b are provided are integrated.

As illustrated in FIG. 18(b), exposed core portions are generated also in the transformer 301 because of the above-described reason.

Moreover, as illustrated in FIG. 18(c), the base part 302b and the base part 302c which are formed integrally with the hollow winding drum part 302a respectively extend from opposite sides in a core part composed of a first core 305 and a second core 306 in the transformer 301.

Note that, as illustrated in FIG. 18(d), it is assumed that, in the transformer 301, a voltage input from the terminal parts 303a in an input side (primary side) is converted into a predetermined voltage, and thereafter output from the terminal parts 303b in an output side (secondary side). In a case where the core part composed of the first core 305 and the second core 306 has a primary-side potential, in terms of the necessary safety standard, it is necessary to secure a predetermined insulation distance from the exposed core portion A and the exposed core portion B for the terminal parts 303b, but it is not necessary to secure the predetermined insulation distance from the exposed core portion C or the exposed core portion D for the terminal parts 303a in the input side (primary side).

On the other hand, in a case where the terminal parts 303b are set as the terminal parts in the input side (primary side) and the core part composed of the first core 305 and the second core 306 has a secondary-side potential, it is necessary to secure the predetermined insulation distance from the exposed core portion A and the exposed core portion B for the terminal parts 303b, but in terms of the necessary safety standard, it is not necessary to secure the predetermined insulation distance from the exposed core portion C or the exposed core portion D for the terminal parts 303a in the output side (secondary side).

As illustrated in FIG. 18(d), the exposed core portion A, the exposed core portion B, the exposed core portion C, and the exposed core portion D which are indicated with dotted-line circles in the drawing exist at both ends of the base part 302b and both ends of the base part 302c, and the base part 302c formed integrally with the hollow winding drum part 302a is formed in line symmetry with respect to a dotted line G-H in the drawing. In addition, the base part 302b formed integrally with the hollow winding drum part 302a is also formed in line symmetry with respect to the dotted line G-H in the drawing.

Note that, the base part 302c in which the terminal parts 303b are provided is formed so as to be longer than the base part 302b, in which the terminal parts 303a are provided, in order to secure the predetermined insulation distance from the exposed core portion A and the exposed core portion B, as illustrated.

Since the base part 302c has such a shape, it is possible to set a distance from the exposed core portion A in an upper side of the drawing to the closest terminal part 303b as an insulation distance E (for example, 7 mm), while it is also possible to set a distance from the exposed core portion B in a lower side of the drawing to the closest terminal part 303b as an insulation distance F (for example, 7 mm).

As above, in the conventional transformer 301, in order to secure the insulation distances in this manner, the base part 302c having the shape in line symmetry with respect to the dotted line G-H in the drawing, which passes through the center of a line connecting the exposed core portion A and the exposed core portion B and is orthogonal to the line connecting the exposed core portion A and the exposed core portion B, is provided, and the terminal parts 303b are provided in an end part of the base part 302c, which is farther from the first core 305 and the second core 306.

Accordingly, in the conventional transformer 301, a size of the base part 302c included in the bobbin body 302 is increased in order to secure insulation characteristics thereof, so that it is difficult to realize further size reduction of the transformer and further size reduction of a power source device including the transformer.

FIG. 19 is a view illustrating a schematic configuration of a conventional transformer provided with a bobbin body in which a hollow winding drum part (the hollow winding drum part is to include a base supporting a hollow winding drum) and a base part in which terminal parts are formed are integrated and RM-type cores. The RM type here is a name of a specific manufacturer manufacturing the core, and has a shape with which magnetic flux is able to be used effectively compared with the E-type one, similarly to the PQ type.

FIG. 19(a) illustrates a plan view of a transformer 401, which is viewed from above, FIG. 19(b) illustrates a perspective view of the transformer 401, FIG. 19(c) illustrates a side view of the transformer 401, and FIG. 19(d) illustrates a plan view of the transformer 401 which is set so that a second core 406 is positioned in an upper side, which is viewed from above.

Note that, the transformer 401 illustrated in FIG. 19 is different from the above-described transformer 201 illustrated in FIG. 17 only in types of cores between the RM-type core and the PQ-type core.

As illustrated in FIG. 17 and FIG. 19, the RM-type core and the PQ-type core are different in terms of the shapes of the cores themselves, and accordingly different also in terms of the shapes of opening portions.

As illustrated in FIG. 19(a) and FIG. 19(b), a first core 405 and the second core 406 included in the transformer 401 are the RM-type cores. Similarly to the above-described PQ-type cores, also in such RM-type cores, the first core 405 and the second core 406 are required to include opening portions 405a and 406a through which a base part 402b formed integrally with a hollow winding drum part 402a extends to an outside of a core part composed of the first core 405 and the second core 406, so that, due to the structures thereof, the exposed core portions are generated.

Moreover, as illustrated in FIG. 19(c), in the transformer 401, the base part 402b formed integrally with the hollow winding drum part 402a extends from one side of the core part composed of the first core 405 and the second core 406.

Note that, it is assumed that, in the transformer 401 in the drawing, a voltage input from terminal parts (not illustrated) in an input side (primary side) is converted into a predetermined voltage, and thereafter output from terminal parts 403 in an output side (secondary side). In a case where the core part composed of the first core 405 and the second core 406 has a primary-side potential, in terms of the necessary safety standard, it is necessary to secure a predetermined insulation distance from the exposed core portion A and the exposed core portion B for the terminal parts 403.

As illustrated in FIG. 19(d), the exposed core portion A and the exposed core portion B which are indicated with dotted-line circles in the drawing exist at both ends of the base part 402b, and the exposed core portion C and the exposed core portion D which are indicated with dotted-line circles in the drawing exist in a side opposite to a side in which the base part 402b is formed, and the base part 402b formed integrally with the hollow winding drum part 402a is formed in line symmetry with respect to a dotted line K-L in the drawing.

Since the base part 402b has such a shape, it is possible to set a distance from the exposed core portion A in an upper side of the drawing to the closest terminal part 403 as an insulation distance I (for example, 7 mm), while it is also possible to set a distance from the exposed core portion B in a lower side of the drawing to the closest terminal part 403 as an insulation distance J (for example, 7 mm).

As above, in the conventional transformer 401, in order to secure the insulation distances in this manner, the base part 402b having the shape in line symmetry with respect to the dotted line K-L in the drawing, which passes through the center of a line connecting the exposed core portion A and the exposed core portion B and is orthogonal to the line connecting the exposed core portion A and the exposed core portion B, is provided, and the terminal parts 403 are provided in an end part of the base part 402b, which is farther from the first core 405 and the second core 406.

Accordingly, in the conventional transformer 401, a size of the base part 402b included in the bobbin body 402 is increased in order to secure insulation characteristics thereof, so that it is difficult to realize further size reduction of the transformer and further size reduction of a power source device including the transformer.

FIG. 20 is a view illustrating a schematic configuration of another conventional transformer provided with a bobbin body in which a hollow winding drum part (the hollow winding drum part is to include a base supporting a hollow winding drum) and a base part in which terminal parts are formed are integrated and RM-type cores.

FIG. 20(a) illustrates a plan view of a transformer 501, which is viewed from above, FIG. 20(b) illustrates a perspective view of the transformer 501, FIG. 20(c) illustrates a side view of the transformer 501, and FIG. 20(d) illustrates a plan view of the transformer 501 which is set so that a second core 506 is positioned in an upper side, which is viewed from above.

Note that, the transformer 501 illustrated in FIG. 20 is different from the above-described transformer 301 illustrated in FIG. 18 only in types of cores between the RM-type core and the PQ-type core.

As illustrated in FIG. 20(a) and FIG. 20(b), a first core 505 and the second core 506 included in the transformer 501 are the RM-type cores. Similarly to the above-described PQ-type cores, also in such RM-type cores, the first core 505 and the second core 506 are required to include opening portions 505a and 506a through which a base part 502b and a base part 502c which are formed integrally with a hollow winding drum part 502a extend to an outside of a core part composed of the first core 505 and the second core 506, so that, due to the structures thereof, the exposed core portions are generated.

As illustrated in FIG. 18 and FIG. 20, the RM-type core and the PQ-type core are different in terms of the shapes of the cores themselves, and accordingly different also in terms of the shapes of the opening portions.

Moreover, as illustrated in FIG. 20(c), the base part 502b and the base part 502c which are formed integrally with the hollow winding drum part 502a respectively extend from opposite sides in the core part composed of the first core 505 and the second core 506 in the transformer 501.

Note that, it is assumed that, in the transformer 501 in the drawing, a voltage input from terminal parts 503a in an input side (primary side) is converted into a predetermined voltage, and thereafter output from terminal parts 503b in an output side (secondary side). In a case where the core part composed of the first core 505 and the second core 506 has a primary-side potential, in terms of the necessary safety standard, it is necessary to secure a predetermined insulation distance from the exposed core portion A and the exposed core portion B for the terminal parts 503b, but it is not necessary to secure the predetermined insulation distance from the exposed core portion C or the exposed core portion D for the terminal parts 503a.

As illustrated in FIG. 20(d), the exposed core portion A and the exposed core portion B which are indicated with dotted-line circles in the drawing exist at both ends of the base part 502c, and the exposed core portion C and the exposed core portion D which are indicated with dotted-line circles exist at both ends of the base part 502b, and the base part 502c formed integrally with the hollow winding drum part 502a is formed in line symmetry with respect to a dotted line O-P in the drawing. In addition, the base part 502b formed integrally with the hollow winding drum part 502a is also formed in line symmetry with respect to the dotted line O-P in the drawing.

Note that, the base part 502c in which the terminal parts 503b are provided is formed so as to be longer than the base part 502b, in which the terminal parts 503a are provided, in order to secure the predetermined insulation distance from the exposed core portion A and the exposed core portion B, as illustrated.

Since the base part 502c has such a shape, it is possible to set a distance from the exposed core portion A in an upper side of the drawing to the closest terminal part 503b as an insulation distance M (for example, 7 mm), while it is also possible to set a distance from the exposed core portion B in a lower side of the drawing to the closest terminal part 503b as an insulation distance N (for example, 7 mm).

As above, in the conventional transformer 501, in order to secure the insulation distances in this manner, the base part 502c having the shape in line symmetry with respect to the dotted line O-P in the drawing, which passes through the center of a line connecting the exposed core portion A and the exposed core portion B and is orthogonal to the line connecting the exposed core portion A and the exposed core portion B, is provided, and the terminal parts 503b are provided in an end part of the base part 502c, which is farther from the first core 505 and the second core 506.

Accordingly, in the conventional transformer 501, a size of the base part 502c included in the bobbin body 502 is increased in order to secure insulation characteristics thereof, so that it is difficult to realize further size reduction of the transformer and further size reduction of a power source device including the transformer.

FIG. 21 is a view illustrating an adaptor 601 including the conventional transformer 501 (having the RM-type cores) which is illustrated in FIG. 20.

FIG. 21(a) illustrates a perspective view of the adaptor 601, FIG. 21(b) illustrates a view illustrating a shape of an input part of the adaptor 601, FIG. 21(c) illustrates a side view of the adaptor 601, and FIG. 21(d) illustrates a plan view of the adaptor 601.

As illustrated in FIG. 21(a), the adaptor 601 is provided with the transformer 501 in which the size of the base part is large and which is difficult to be miniaturized, so that a volume thereof becomes 88.6 cc, which is comparatively large.

Note that, as illustrated in FIG. 21(c) and FIG. 21(d), since the adaptor 601 has a height of 28.4 mm, a lateral width of 124.8 mm, and a depth of 25.0 mm, the volume thereof is 88.6 cc.

The reason why the volume becomes comparatively large in this manner is because, as illustrated in a region Q of FIG. 21(c), the base part of the transformer 501 interferes with a member included in the adaptor 601, such as a capacitor, for example.

FIG. 22 is a view illustrating an adaptor 701 including the conventional transformer 301 (having the PQ-type cores) which is illustrated in FIG. 18.

FIG. 22(a) illustrates a perspective view of the adaptor 701, FIG. 22(b) illustrates a view illustrating a shape of an input part of the adaptor 701, FIG. 22(c) illustrates a plan view of the adaptor 701, and FIG. 22(d) illustrates a side view of the adaptor 701.

As illustrated in FIG. 22(a), the adaptor 701 is provided with the transformer 301 in which the size of the base part is large and which is difficult to be miniaturized, so that a volume thereof becomes 89.7 cc, which is comparatively large.

Note that, as illustrated in FIG. 22(b) and FIG. 22(c), since the adaptor 701 has a height of 25.0 mm, a lateral width of 78.0 mm, and a depth of 46.0 mm, the volume thereof is 89.7 cc.

Because of a shape different from that of the adaptor 601 having a long and thin shape, which is illustrated in FIG. 21, the adaptor 701 illustrated in FIG. 22 is referred to also as a matchbox-shaped adaptor.

FIG. 23 is a view illustrating an adaptor 801 including the conventional transformer 501 (having the RM-type cores) which is illustrated in FIG. 20.

Note that, the adaptor 801 is different from the adaptor 601 having the long and thin shape, which is illustrated in FIG. 21 in that the adaptor 801 is a matchbox-shaped adaptor.

FIG. 23(a) illustrates a perspective view of the adaptor 801, FIG. 23(b) illustrates a view illustrating a shape of an input part of the adaptor 801, FIG. 23(c) is a plan view of the adaptor 801, and FIG. 23(d) is a side view of the adaptor 801.

As illustrated in FIG. 23(a), the adaptor 801 is provided with the transformer 501 in which the size of the base part is large and which is difficult to be miniaturized, so that a volume thereof becomes 89.7 cc, which is comparatively large.

Note that, as illustrated in FIG. 23(b) and FIG. 23(c), since the adaptor 801 has a height of 25.0 mm, a lateral width of 78.0 mm, and a depth of 46.0 mm, the volume thereof is 89.7 cc.

As above, in each of the conventional transformers illustrated in FIG. 17 to FIG. 20, the size of the base part becomes large in order to secure the insulation characteristics, and the base part interferes with a peripheral component such as a capacitor, so that it is difficult to realize further size reduction of the transformer and further size reduction of a power source device including the transformer (adaptor, for example).

The invention is made in view of the aforementioned conventional problems, and an object thereof is to provide a transformer which secures an insulation property and is capable of realizing further size reduction, and a power source device including the transformer.

### Solution to Problem

In order to solve the aforementioned problems, a transformer of the invention is a transformer, including: a bobbin body in which a base and a hollow winding drum provided on the base are integrated; and a first core and a second core which are separately inserted into both ends of a hollow hole of the winding drum so as to hold the base therebetween, in which a first opening portion through which the base extends to an outside of one side of a core part which is formed by stacking the first core and the second core is formed in the first core and the second core, and a notched part which is closer to one region of a first region and a second region in each of which an end part of the base and the first opening portion intersect is formed in a portion of the base, which extends from the first opening portion.

According to the aforementioned configuration, the notched part which is closer to one region of the first region and the second region in each of which the end part of the base and the first opening portion intersect is formed in the portion of the base, which extends from the first opening portion.

With existence of the notched part, it is possible to realize size reduction of the transformer.

Moreover, it is possible to spatially secure insulation characteristics by the notched part of the base, so that it is possible to shorten a length of the base compared with a case where the insulation characteristics are secured only by the base, and it is possible to freely form a shape of the base compared with the case where the insulation characteristics are secured only by the base part.

Thus, according to the aforementioned configuration, it is possible to realize a transformer which secures an insulation property and is capable of further size reduction.

In order to solve the aforementioned problems, a power source device of the invention includes the aforementioned transformer.

According to the aforementioned configuration, since the transformer is included, it is possible to realize a power source device which secures an insulation property and is capable of further size reduction.

### Advantageous Effects of Invention

The transformer and the power source device including the transformer of the invention are able to provide a transformer and a power source device which secure an insulation property and are capable of realizing further size reduction.

### BRIEF DESCRIPTION OF DRAWINGS

FIG. 1 is a view illustrating a schematic configuration of a transformer of Embodiment 1 of the invention.

FIG. 2 is a view illustrating a schematic configuration of a transformer of Embodiment 2 of the invention.

FIG. 3 is a view illustrating a schematic configuration of a transformer of Embodiment 3 of the invention.

FIG. 4 is a view illustrating a schematic configuration of a transformer of Embodiment 4 of the invention.

FIG. 5 is a view illustrating a schematic configuration of an adaptor including the transformer illustrated in FIG. 4.

FIG. 6 is a view illustrating a schematic configuration of a transformer of Embodiment 5 of the invention.

FIG. 7 is a view illustrating a schematic configuration of a transformer of Embodiment 6 of the invention.

FIG. 8 is a view illustrating a schematic configuration of an adaptor including a transformer of Embodiment 7 of the invention.

FIG. 9 is a view illustrating a schematic configuration of an adaptor including a transformer of Embodiment 8 of the invention.

FIG. 10 is a view illustrating a schematic configuration of an adaptor including a transformer of Embodiment 9 of the invention.

FIG. 11 is a view illustrating a schematic configuration of an adaptor including a transformer of Embodiment 10 of the invention.

FIG. 12 is a view illustrating a schematic configuration of an adaptor including a transformer of Embodiment 11 of the invention.

FIG. 13 is a view illustrating a schematic configuration of an adaptor including a transformer of Embodiment 12 of the invention.

FIG. 14 is a view illustrating a schematic configuration of a transformer of Embodiment 13 of the invention.

FIG. 15 is a view for explaining a clearance and a creepage distance.

FIG. 16 is a view illustrating a schematic configuration of a conventional transformer which uses ferrite cores.

FIG. 17 is a view illustrating a schematic configuration of a conventional transformer including PQ-type cores.

FIG. 18 is a view illustrating a schematic configuration of another conventional transformer including PQ-type cores.

FIG. 19 is a view illustrating a schematic configuration of a conventional transformer including RM-type cores.

FIG. 20 is a view illustrating a schematic configuration of another conventional transformer including RM-type cores.

FIG. 21 is a view illustrating a schematic configuration of a conventional adaptor including the transformer illustrated in FIG. 20.

FIG. 22 is a view illustrating a schematic configuration of a conventional adaptor including the transformer illustrated in FIG. 18.

FIG. 23 is a view illustrating a schematic configuration of a conventional adaptor including the transformer illustrated in FIG. 20.

### DESCRIPTION OF EMBODIMENTS

Hereinafter, embodiments of the invention will be described in detail with reference to drawings. However, the dimensions, materials, shapes, and relative arrangement of components described in the embodiments are merely exemplary embodiments, and are not intended to restrict the scope of the invention.

In addition, there are two types of safety distance, namely, a clearance and a creepage distance, and it is necessary to secure an appropriate distance for each of them. As one example, a clearance of 4 mm and a creepage distance of 7 mm are set.

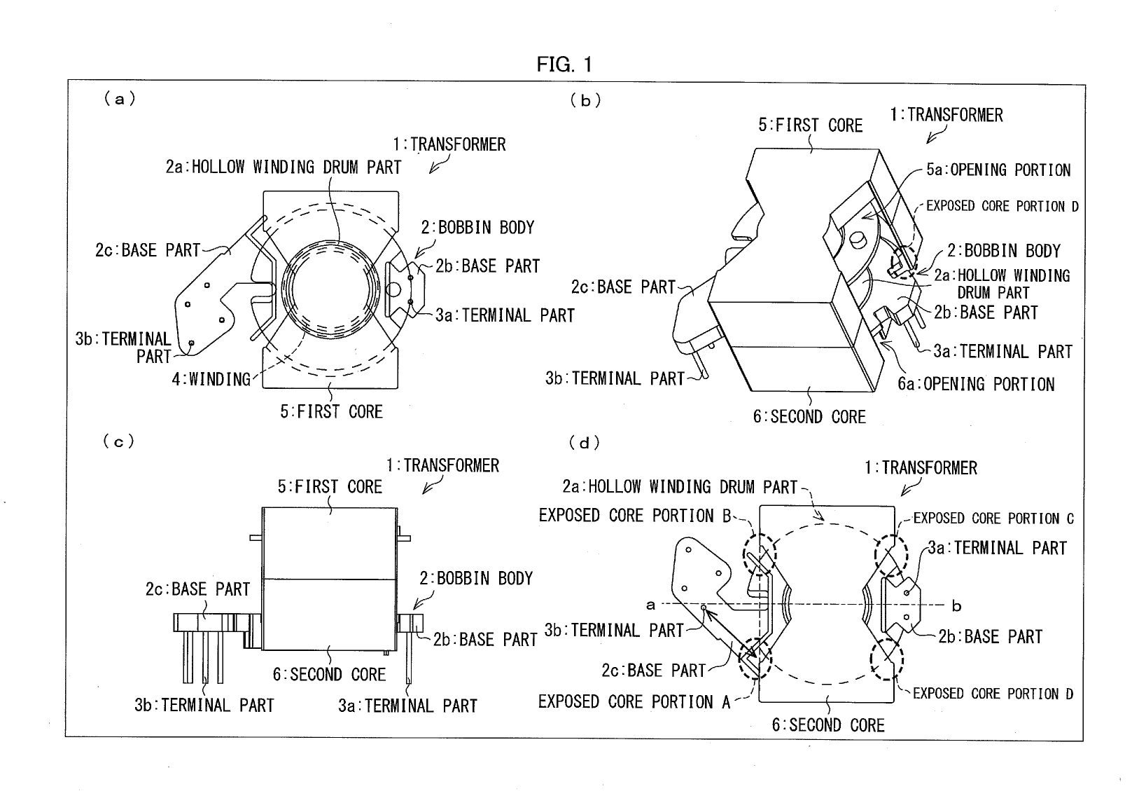

The embodiments of the invention are described as follows with reference to FIG. 1 to FIG. 15.

### Embodiment 1

One embodiment of the invention is described as follows with reference to FIG. 1.

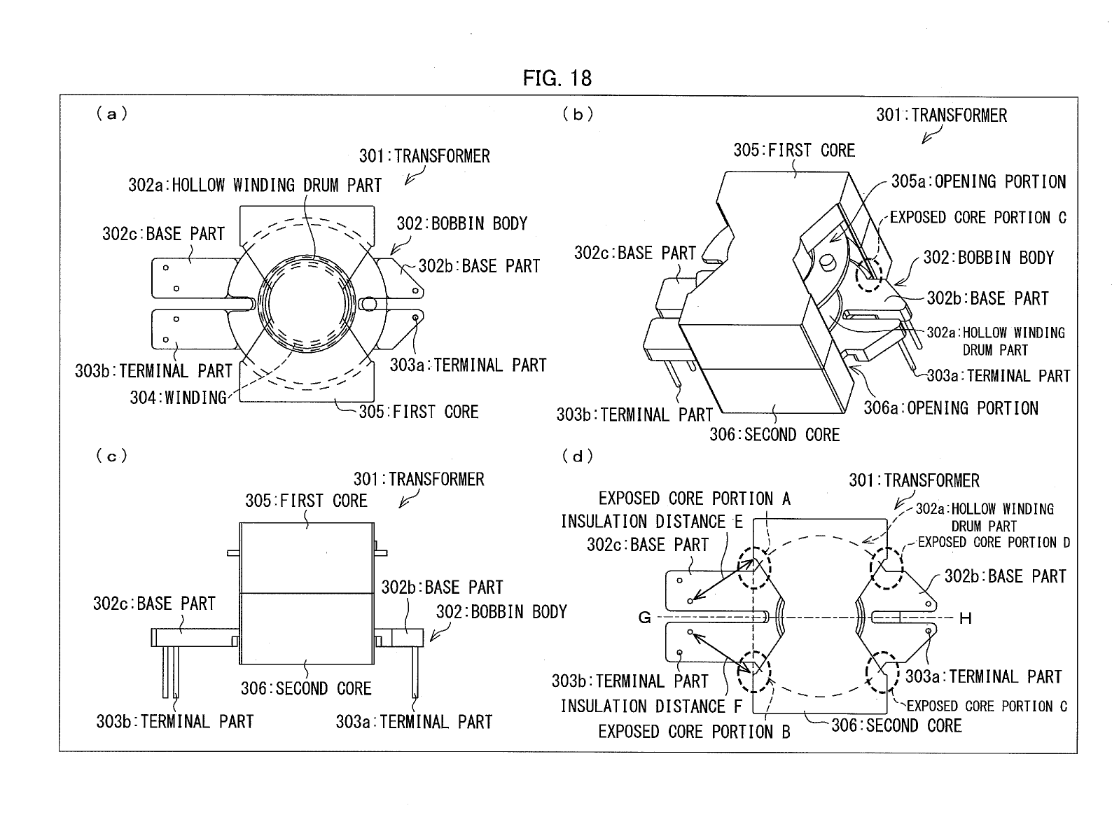

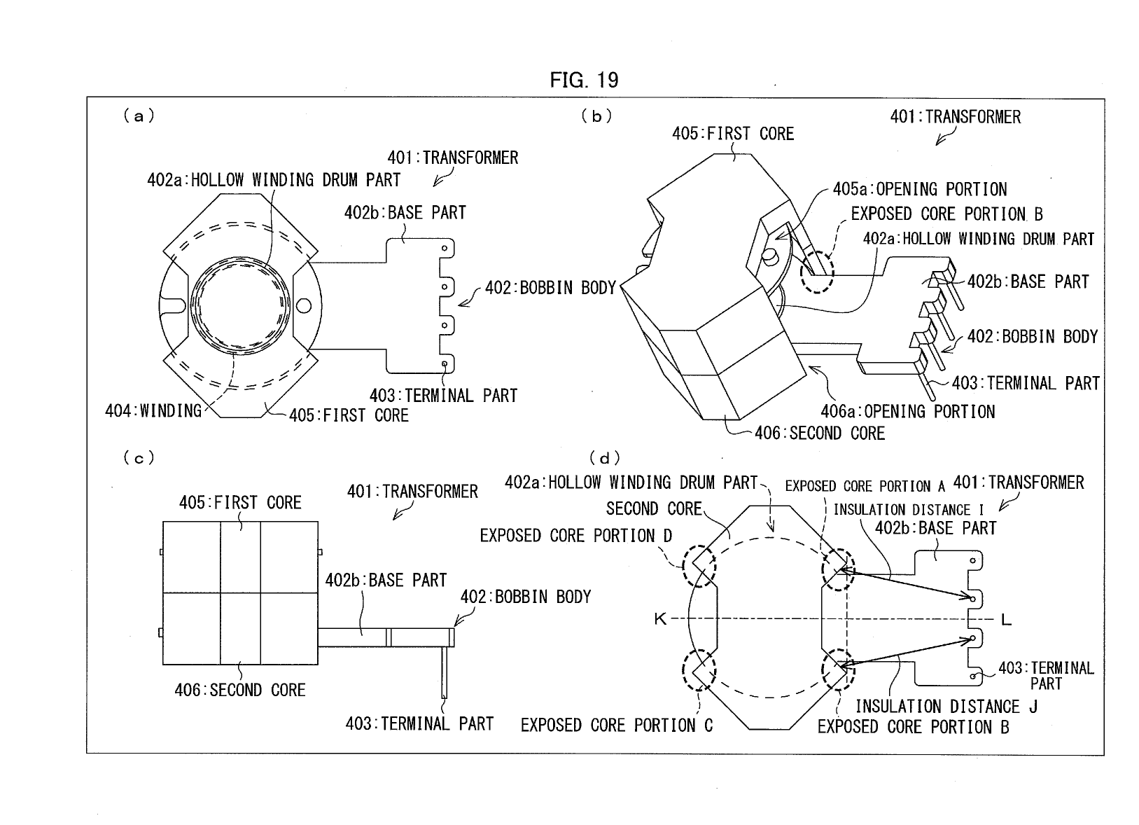

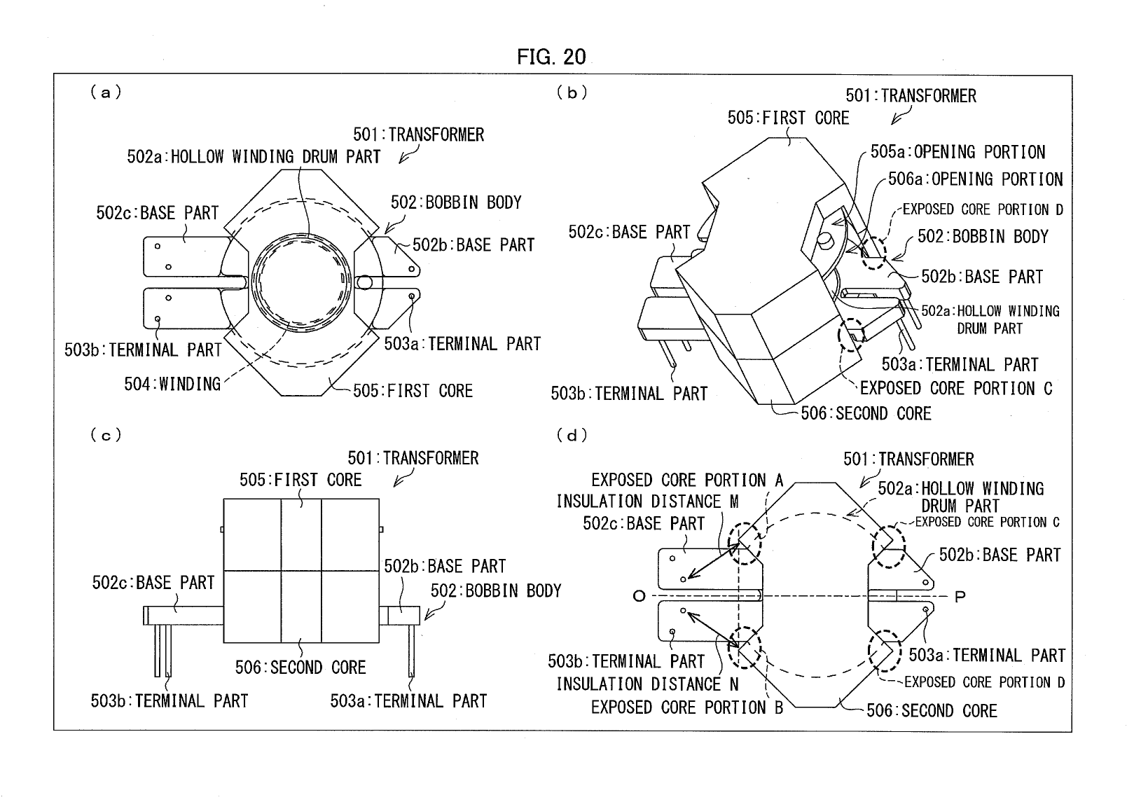

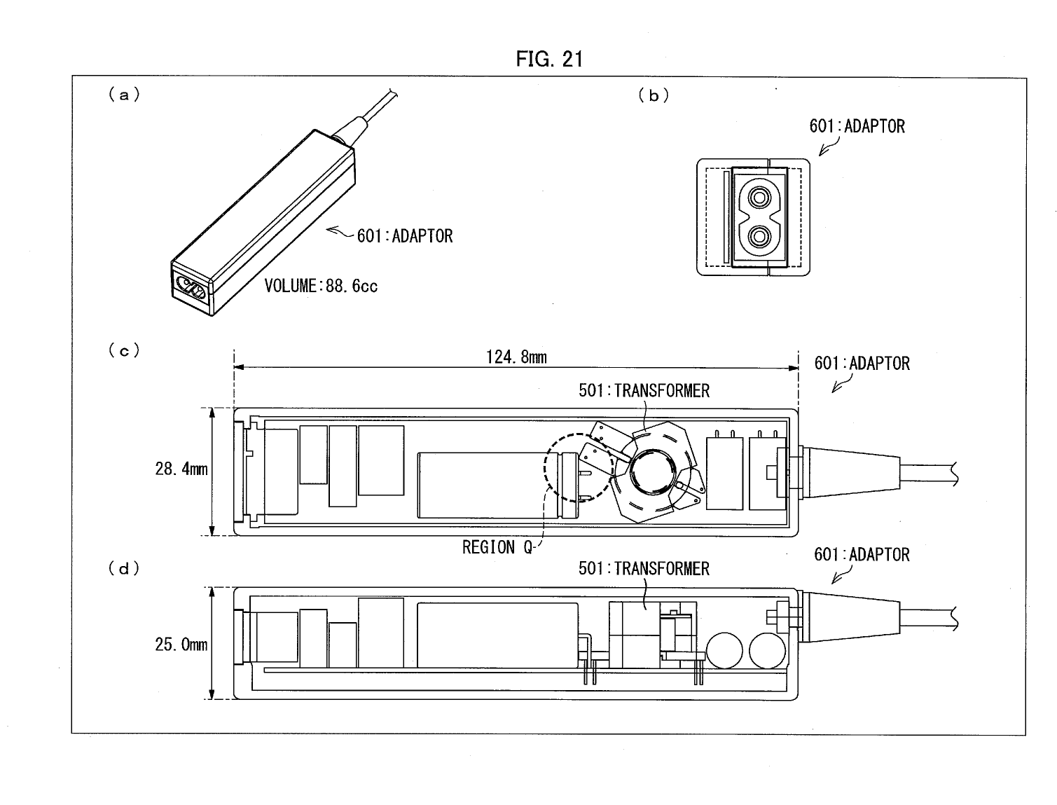

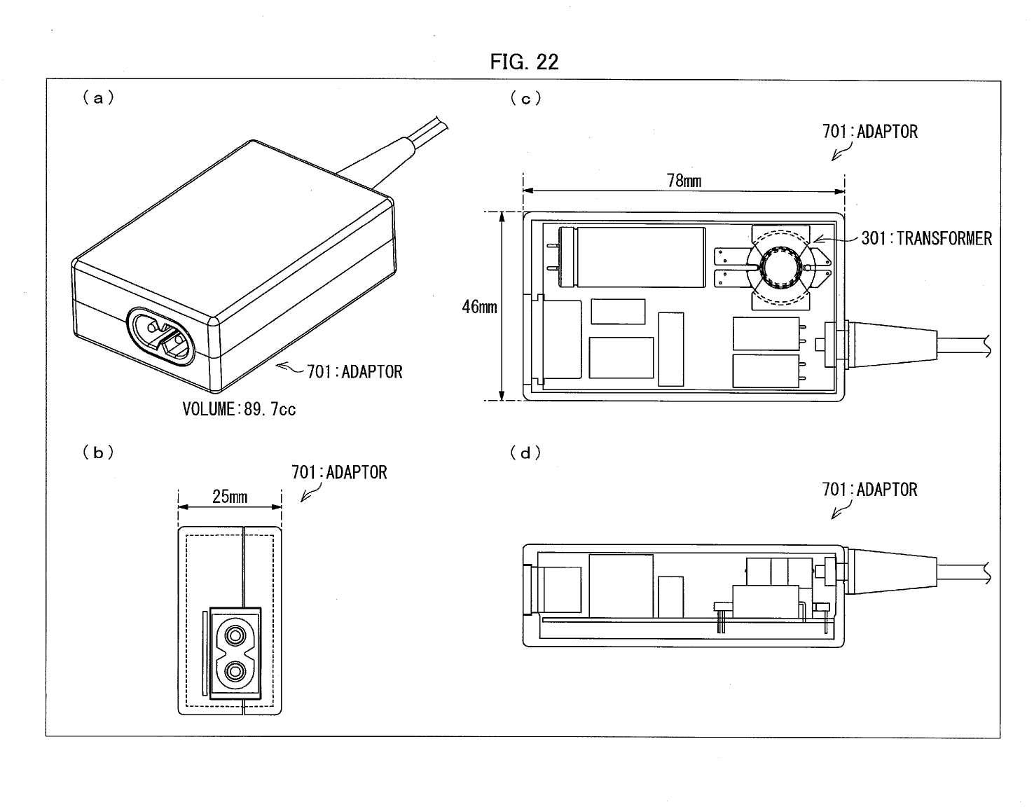

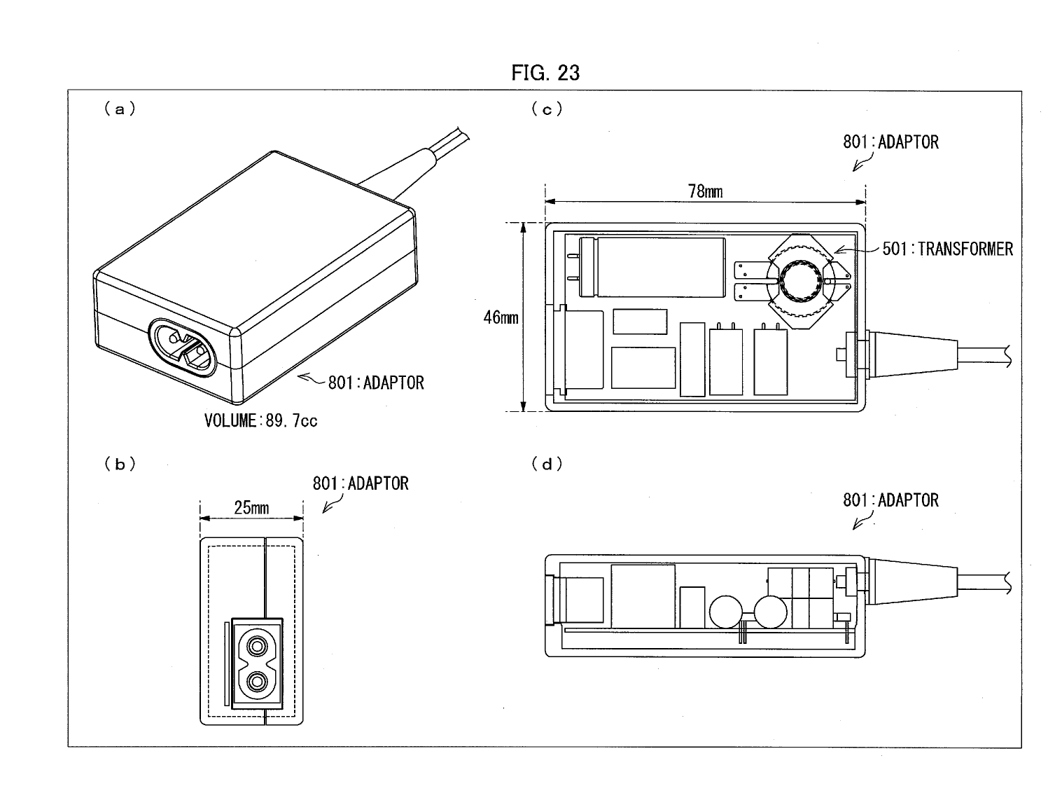

Note that, a transformer 1 illustrated in FIG. 1 is different from the above-described transformer 301 illustrated in FIG. 18 only in terms of the shapes of base parts provided in a bobbin body.

FIG. 1 is a view illustrating a schematic configuration of the transformer 1 provided with a bobbin body 2 in which a hollow winding drum part 2a (the hollow winding drum part 2a is to include a base supporting a hollow winding drum), a base part 2b in which terminal parts 3a are formed, and a base part 2c in which terminal parts 3b are formed are integrated and PQ-type cores (a first core 5 and a second core 6).

FIG. 1(a) illustrates a plan view of the transformer 1, which is viewed from above, FIG. 1(b) illustrates a perspective view of the transformer 1, FIG. 1(c) illustrates a side view of the transformer 1, and FIG. 1(d) illustrates a plan view of the transformer 1 which is set so that the second core 6 is positioned in an upper side, which is viewed from above.

(Bobbin Body)

As illustrated in FIG. 1(a), in the bobbin body 2, the hollow winding drum part 2a, the base part 2b in which the terminal parts 3a are provided, and the base part 2c in which the terminal parts 3b are provided are integrated. Note that, examples of being integrated include both of a case where the hollow winding drum part 2a, the base part 2b, and the base part 2c are made of different materials, and fixed and integrated by, for example, fitting or sticking, and a case where the hollow winding drum part 2a, the base part 2b, and the base part 2c are made of the same material, and molded in a single step.

Moreover, the hollow winding drum part 2a includes the hollow winding drum and the supporting base of the hollow winding drum, and the hollow winding drum and the supporting base therefor may be made of different materials, and fixed and integrated by, for example, fitting or sticking, or may be made of the same material, and molded in a single step.

Note that, in the present embodiment, the hollow winding drum part 2a, the base part 2b, and the base part 2c are made of insulating resin.

Moreover, the hollow winding drum part 2a is wound with windings 4 serving as a primary winding and a secondary winding, which are formed of copper wires, for example, and, in this case, the primary winding and the secondary winding are electrically insulated by an insulating member. Note that, instead of the windings, planar coils or the like may be used.

(First Core and Second Core)

As illustrated in FIG. 1(b) and FIG. 1(c), the first core 5 and the second core 6 are PQ-type cores, and by separately inserting protrusions in the centers of the first core 5 and the second core 6 into a hollow portion of the winding drum part 2a from up and down directions, and stacking protrusions in respective end parts of the first core 5 and the second core 6 with each other for fixation, the transformer 1 in which the bobbin body 2 and the first core 5 and the second core 6 are combined is obtained.

The first core 5 and the second core 6 are respectively provided with opening portions 5a and 6a through which the base part 2b and the base part 2c formed integrally with the hollow winding drum part 2a extend to the outside of a core part composed of the first core 5 and the second core 6.

Note that, the first core 5 and the second core 6 are formed of a ferrite material, and such a ferrite material is able to be obtained by firing a mixture of, for example, nickel, manganese, zinc, or the like and iron oxide. Since the ferrite material has semiconductor characteristics, it is necessary to secure a predetermined insulation distance between the first core 5 and the second core 6 which are made of the ferrite material and each conductive body such as a body of a component, a pattern of a printed-circuit board, or the terminal parts 3a or 3b.

Note that, though description will be given in the present embodiment by taking, as an example, a vertical transformer in which the respective protrusions in the centers of the first core 5 and the second core 6 are inserted into the hollow portion of the winding drum part 2a from the up and down directions, a horizontal transformer in which respective protrusions in centers of a first core and a second core are inserted into a hollow portion of a winding drum part extending in a right-and-left direction may be used.

(Exposed Core Portions)

With a countermeasure such as winding an insulating tape around the outer sides of the first core 5 and the second core 6, it is possible to secure the predetermined insulation distance. However, as illustrated in FIG. 1(b), there are portions which are difficult to be wound with the insulating tape due to the shapes thereof, and, in these portions, exposed core portions are generated. The insulation distance is required to be a distance prescribed by a safety standard as for each of a clearance and a creepage distance. The countermeasure such as winding the tape is an effective countermeasure particularly against the clearance. However, as illustrated in FIG. 1(b), since it is difficult to wind the insulating tape due to the shapes, the exposed core portions are generated. Based on the exposed portions, a discharge path of creepage which goes along the base part and reaches the terminals (surface along a surface of an insulating body) is generated.

The exposed core portions are generated at positions at both ends of the above-described opening portions 5a and 6a through which the base part 2b and the base part 2c formed integrally with the hollow winding drum part 2a extend to the outside of the core part composed of the first core 5 and the second core 6 and at a substantially same height as the base part 2b and the base part 2c.

As above, the first core 5 and the second core 6 in the transformer 1 provided with the bobbin body 2 in which the hollow winding drum part 2a and the base part 2b and the base part 2c are integrated are required to include the opening portions 5a and 6a through which the base part 2b and the base part 2c formed integrally with the hollow winding drum part 2a extend to the outside of the core part composed of the first core 5 and the second core 6, so that, due to the structures thereof, the exposed core portions are generated.

As illustrated in FIG. 1(c), the base part 2b and the base part 2c which are formed integrally with the hollow winding drum part 2a respectively extend from opposite sides in the core part composed of the first core 5 and the second core 6 in the transformer 1.

(Insulation Distance)

The insulation distance is a distance with which electric insulation is achieved between two conductive bodies, and includes a clearance and a creepage distance. In order to achieve electric insulation between two conductive bodies, it is necessary to secure both of the clearance and the creepage distance. The clearance is literally a direct distance between insulated conductors. The creepage distance is a distance along an insulator.

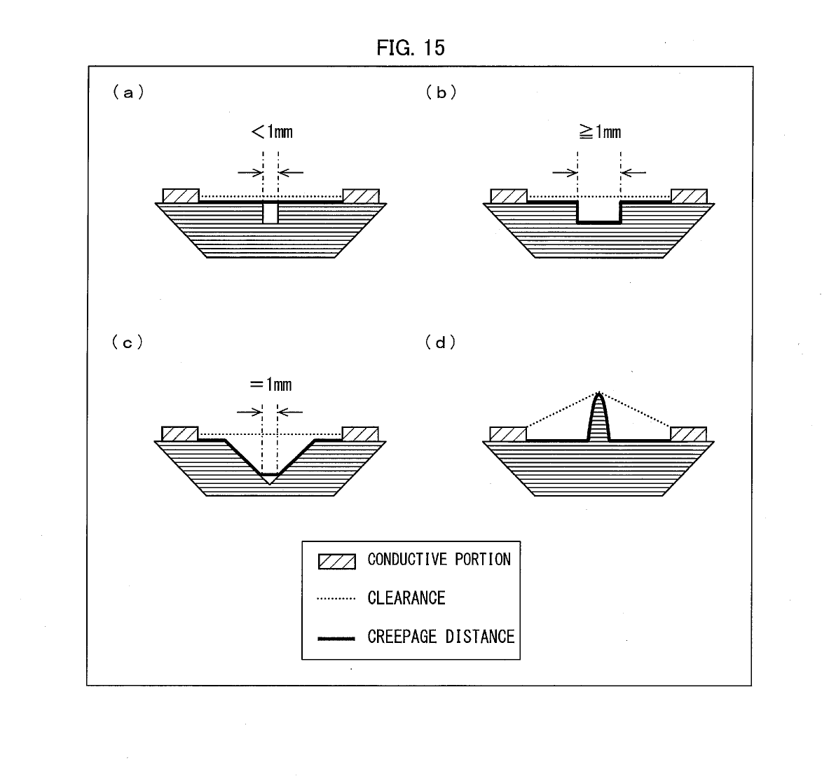

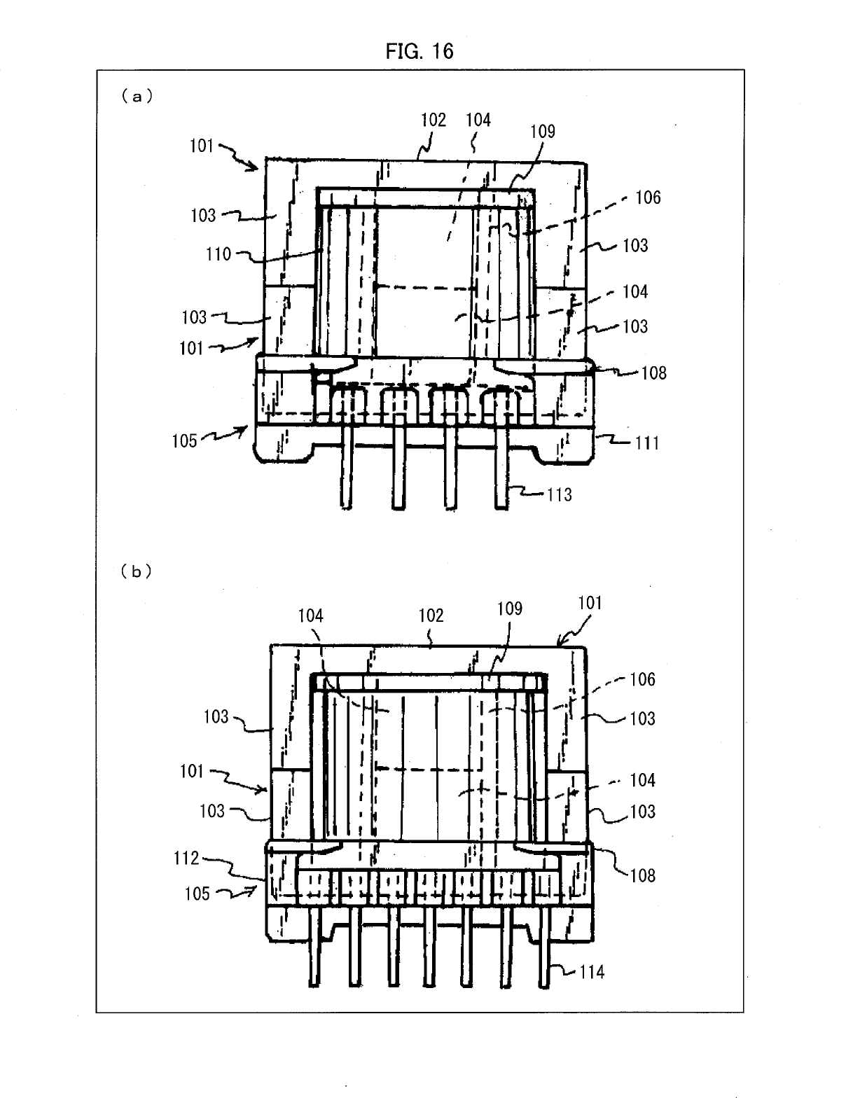

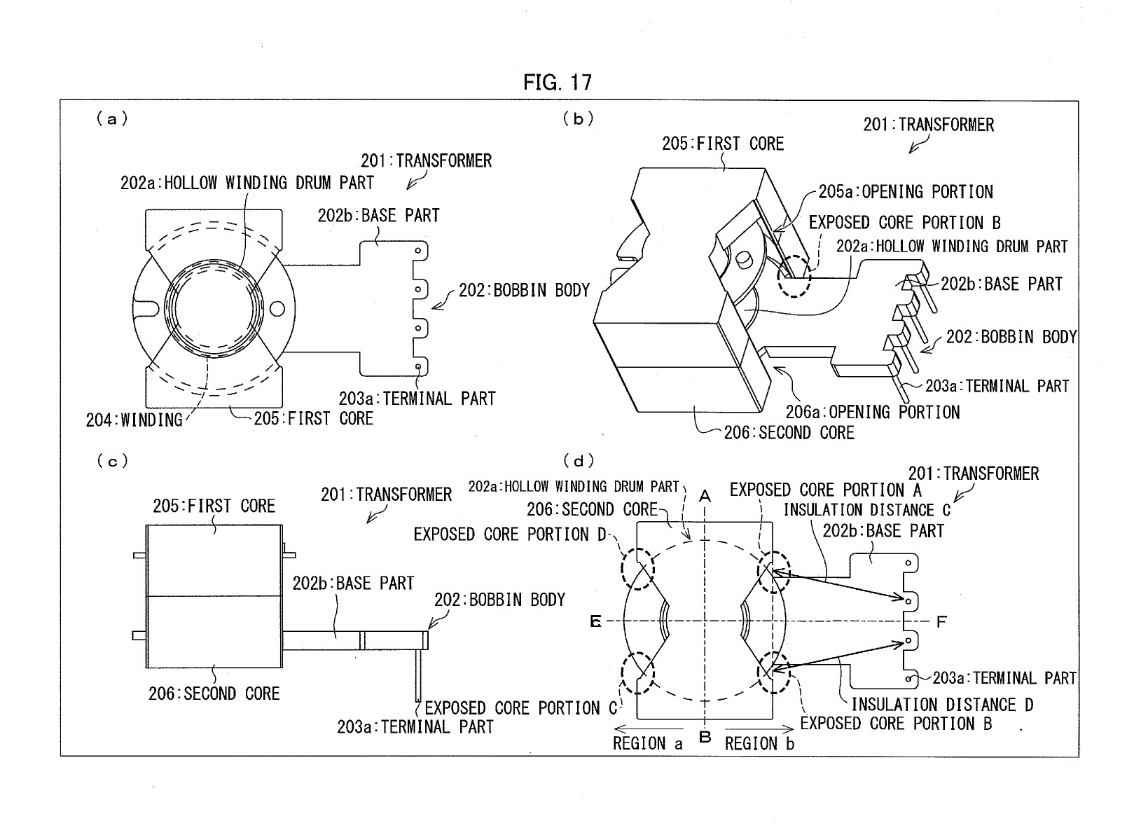

FIG. 15 is a view for explaining the clearance and the creepage distance.

FIG. 15(a) illustrates a clearance and a creepage distance in a case where a recess whose width is less than 1 mm exists on a surface of an insulator between two conductive bodies, and the clearance and the creepage distance are the same in this case. That is, in a case where a voltage is applied between two conductive bodies for discharge in the air, a slit or a recess which is equal to or less than 1 mm is regarded as being absent when performing the discharge.

FIG. 15(b) illustrates a clearance and a creepage distance in a case where a recess whose width is equal to or more than 1 mm exists on a surface of an insulator between two conductive bodies, and the clearance becomes shorter than the creepage distance in this case. That is, a discharge path is not formed over a space equal to or more than 1 mm, and discharge is performed along the insulator. That is, in the case of securing a creepage distance in a limited space, it is effective to provide a slit or a gap which is equal to or more than 1 mm.

FIG. 15(c) illustrates a clearance and a creepage distance in a case where a recess whose width is equal to or more than 1 mm and whose width decreases with depth exists on a surface of an insulator between two conductive bodies, and the clearance becomes shorter than the creepage distance also in this case.

FIG. 15(d) illustrates a clearance and a creepage distance in a case where a protrusion exists on a surface of an insulator between two conductive bodies, and the clearance becomes shorter than the creepage distance also in this case.

By securing, for example, about 7 mm for a distance (creepage distance) along a surface of a base in a transformer, which is from an exposed core portion to the closest terminal part, it is possible to satisfy a safety standard, although this distance changes in accordance with an input/output voltage. Each of the clearance and a safety distance is required to be a distance prescribed by the safety standard, and, in a transformer, since a discharge path is formed along a surface of a bobbin body serving as an insulator between cores and terminals which are generally to be insulated, it is difficult to secure a creepage distance, so that design thereof is important. When a conductor portion is wound by a tape or covered with an insulating cover, it is possible to comparatively easily secure the clearance, but the creepage distance which is defined along the insulator cannot be secured only by sticking a tape in many cases, so that securing the creepage distance is the point of size reduction of a transformer.

Note that, in the present specification, an insulation distance from an exposed core portion to a terminal part is schematically indicated with an arrow. The insulation distance is originally a path along a surface of a bobbin. Moreover, a clearance and an insulation distance which are necessary for necessary equipment change in accordance with a conforming safety standard. In addition, the above-described example of the slit of 1 mm changes also in accordance with a defacement degree. The present application described above is merely one example and is not limited thereto.

(Shape of Base Part)

Conventionally, in order to secure a predetermined insulation distance from each of such exposed core portions to each of terminal parts, a shape of a base part is formed in line symmetry with respect to a line which passes through the centers of lines each connecting the exposed core portions positioned at both ends of the base part and is orthogonal to the lines each connecting the exposed core portions.

On the other hand, in the present embodiment, as illustrated in FIG. 1(d), four sites indicated with dotted-line circles in the drawing (exposed core portions A to D) are exposed core portions, and the base part 2b formed integrally with the hollow winding drum part 2a is formed in line symmetry with respect to a dotted line a-b in the drawing. Then, for each of the terminal parts 3a formed in the base part 2b, it is not necessary to secure the predetermined insulation distance from the exposed core portion C or the exposed core portion D because of the following reason.

For the transformer 1, it is assumed that a voltage input from the terminal parts 3b in an input side (primary side) is converted into a predetermined voltage, and thereafter output from the terminal parts 3a in an output side (secondary side). When it is assumed that the core part composed of the first core 5 and the second core 6 has a secondary-side potential, in terms of the necessary safety standard, it is necessary to secure the predetermined insulation distance from the exposed core portion A and the exposed core portion B for the terminal parts 3b, but it is not necessary to secure the predetermined insulation distance from the exposed core portion C or the exposed core portion D for terminal parts 3a.

Accordingly, it is not necessary to secure the predetermined insulation distance from the exposed core portion C or the exposed core portion D for the terminal parts 3a of the base part 2b, and a length of the base part 2b may be short, so that a base having a shape similar to that of a conventional one may be used.

On the other hand, in the present embodiment, a shape of the base part 2c is different from a shape of a conventional base, and is not formed in line symmetry with respect to the dotted line a-b in the drawing, which passes through the center of a line connecting the exposed core portion A and the exposed core portion B and is orthogonal to the line connecting the exposed core portion A and the exposed core portion B, as illustrated in FIG. 1(d).

That is, in the base part 2c, a portion which is closer to one region of the exposed core portion A (first region) and the exposed core portion B (second region) is notched. Note that, the present embodiment is described for a case where the portion which is closer to the exposed core portion B is notched.

Since the base part 2c is notched so that, for each of the terminal parts 3b provided in the base part 2c, a creepage distance from the exposed core portion B is always longer than a creepage distance from the exposed core portion A, it is necessary to secure an insulation distance (creepage distance on the base) only from the exposed core portion A for the terminal parts 3b, and it is not necessary to consider the creepage distance from the exposed core portion B. Further, a distance of a direct distance connecting the exposed portion B to the terminal parts 3b satisfies a necessary clearance (for example, 4 mm), so that there is no problem about the clearance either.

As illustrated, the base part 2c extends in the vicinity of the exposed core portion A, but is notched in the vicinity of the exposed core portion B. Therefore, it is necessary to set a distance from the exposed core portion A to the closest terminal part 3b to be equal to or more than a predetermined value as a distance on the base part 2c. On the other hand, since insulation characteristics are able to be spatially secured in the vicinity of the exposed core portion B with the notched part of the base part 2c, it is possible to shorten a distance from the exposed core portion B to the closest terminal part 3b up to, for example, 4 mm.

For example, by securing, for example, about 7 mm for the distance on the base (creepage distance on the base) from the exposed core portion A to the closest terminal part 3b and securing, for example, about 4 mm for a spatial direct distance from the exposed core portion B to the closest terminal part 3b, it is possible to satisfy the safety standard, although these distances change in accordance with an input/output voltage. The creepage distance from the exposed core portion B to the terminal part 3b is always longer than the creepage distance of the exposed core portion A, and therefore not required to be taken into consideration when designing.

That is, from the exposed core portion B to the closest terminal part 3b in the base part 2c, the creepage distance may be ignored and the clearance may be secured so as to be short, so that it is possible to attain space saving.

Note that, in the present embodiment, as illustrated in FIG. 1(d), the base part 2b is formed in a shape in line symmetry with respect to the dotted line a-b in the drawing, which passes through the center of a line connecting the exposed core portion C and the exposed core portion D and is orthogonal to the line connecting the exposed core portion C and the exposed core portion D, but, without limitation thereto, may be formed asymmetrically with respect to the dotted line a-b in the drawing, as necessary.

As above, as for the base part 2c provided in the transformer 1 of the present embodiment, it is necessary to consider only the insulation distance to the exposed core portion A, and it is not necessary to consider the creepage distance to the exposed core portion B, and the clearance thereto merely needs to be 4 mm. Further, when a shield of an insulator is arranged in a space through which a line obtained by connecting the exposed core portion B and the terminal part 3b with a straight line passes, it becomes possible to further shorten the distance between the exposed core portion B and the terminal part 3b. Accordingly, it is also possible to form a tip portion of the base part 2c in a shape approaching the exposed core portion B as illustrated in FIG. 1(d), thus making it possible to shorten a length of the base part 2c in a right-and-left direction in the drawing.

Thus, it is possible to realize the transformer 1 which secures an insulation property and is capable of further size reduction.

Note that, the shape of the base part 2c used in the present embodiment is merely one example, and the shape is not particularly limited as long as an insulation property is able to be secured and further size reduction is able to be realized.

In addition, a thickness of the base part may be determined as appropriate by considering insulation characteristics to be obtained and an increase in a volume in accordance with an increase in the thickness of the base part.

### Embodiment 2

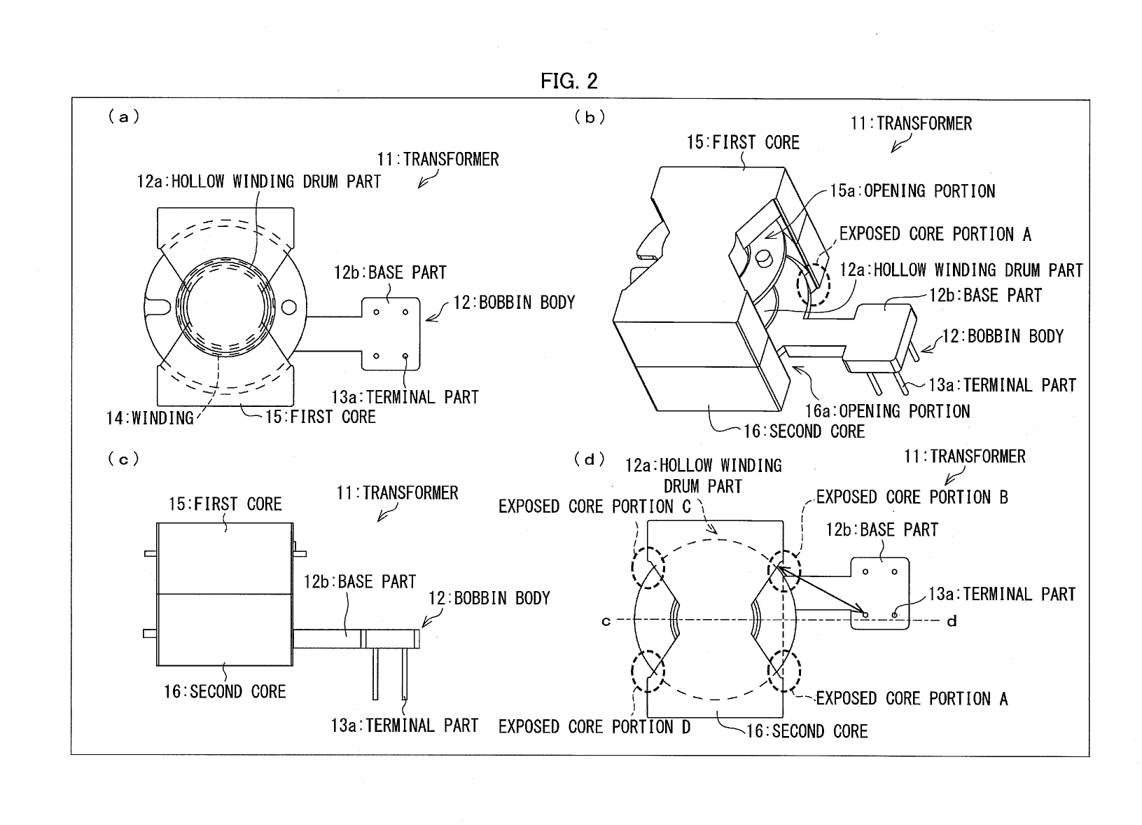

Next, the present embodiment 2 will be described with reference to FIG. 2. In a transformer 11 which will be described in the present embodiment, a shape of a base part 12b provided in a bobbin body 12 is different from the shapes of the base parts of the bobbin body provided in the transformer 1 which has been described in Embodiment 1.

FIG. 2 is a view illustrating a schematic configuration of the transformer 11 provided with the bobbin body 12 in which a hollow winding drum part 12a (the hollow winding drum part 12a is to include a base supporting a hollow winding drum) and the base part 12b in which terminal parts 13a are formed are integrated and PQ-type cores (a first core 15 and a second core 16).

FIG. 2(a) illustrates a plan view of the transformer 11, which is viewed from above, FIG. 2(b) illustrates a perspective view of the transformer 11, FIG. 2(c) illustrates a side view of the transformer 11, and FIG. 2(d) illustrates a plan view of the transformer 11 which is set so that the second core 16 is positioned in an upper side, which is viewed from above.

As illustrated in FIG. 2(a), in the bobbin body 12, the hollow winding drum part 12a and the base part 12b in which the terminal parts 13a are provided are integrated.

As illustrated in FIG. 2(b), the exposed core portions are generated also in the transformer 11 due to the above-described reason.

Moreover, as illustrated in FIG. 2(c), in the transformer 11, the base part 12b formed integrally with the hollow winding drum part 12a extends from one side of a core part composed of the first core 15 and the second core 16.

As illustrated in FIG. 2(d), for the transformer 11, it is assumed that a voltage input from terminal parts (not illustrated) in an input side (primary side) is converted into a predetermined voltage, and thereafter output from the terminal parts 13a in an output side (secondary side). When it is assumed that the core part composed of the first core 15 and the second core 16 has a primary-side potential, in terms of the necessary safety standard, it is necessary to secure a predetermined insulation distance from the exposed core portion A and the exposed core portion B for the terminal parts 13a.

In the present embodiment, differently from a conventional configuration, the shape of the base part 12b is not formed in a shape in line symmetry with respect to a dotted line c-d in the drawing, which passes through the center of a line connecting the exposed core portion A and the exposed core portion B and is orthogonal to the line connecting the exposed core portion A and the exposed core portion B, as illustrated in FIG. 2(d).

That is, in the base part 12b, a portion which is closer to one region of the exposed core portion A (first region) and the exposed core portion B (second region) is notched. Note that, the present embodiment is described for a case where the portion which is closer to the exposed core portion A is notched.

Since the base part 12b is notched so that, for each of the terminal parts 13a provided in the base part 12b, a creepage distance from the exposed core portion A is always longer than a creepage distance from the exposed core portion B, it is necessary to secure an insulation distance (creepage distance along a surface of the base) only from the exposed core portion B, and it is necessary to secure only a clearance of 4 mm from the exposed core portion A.

As illustrated, the base part 12b extends in the vicinity of the exposed core portion B, but is notched in the vicinity of the exposed core portion A. Therefore, it is necessary to set a distance from the exposed core portion B to the closest terminal part 13a to be equal to or more than a predetermined value as a distance on the base part 12b. On the other hand, since it is possible to spatially secure insulation characteristics in the vicinity of the exposed core portion A with the notched part of the base part 12b, only the clearance of 4 mm from the exposed core portion A is required to be secured.

Note that, the base part 12b exists only in the vicinity of the exposed core portion B and does not exist in the vicinity of the exposed core portion A, so that it is possible to efficiently use a space in the vicinity of the exposed core portion A.

As above, in the base part 12b, it is possible to shorten a width in an up-and-down direction in the drawing, so that it is possible to attain space saving.

Thus, it is possible to realize the transformer 11 which secures an insulation property and is capable of further size reduction.

Note that, the shape of the base part 12b used in the present embodiment is merely one example, and the shape is not particularly limited as long as an insulation property is able to be secured and further size reduction is able to be realized.

### Embodiment 3

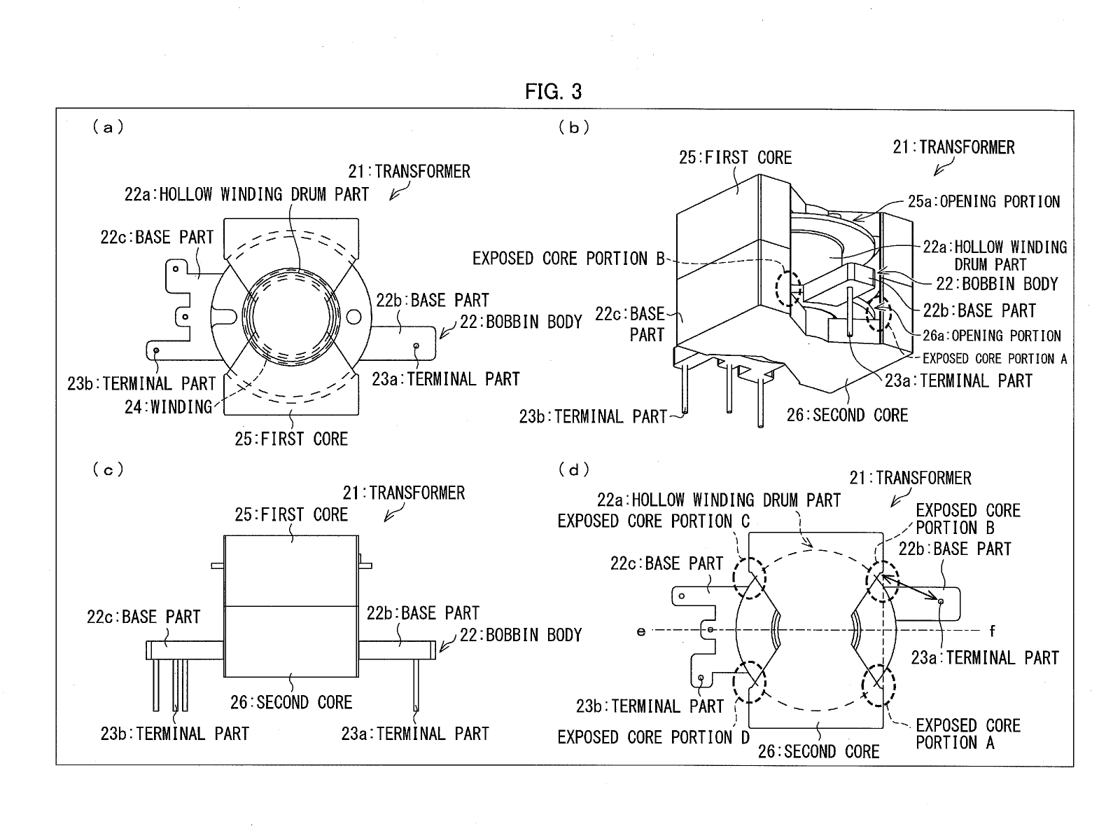

Next, the present embodiment 3 will be described with reference to FIG. 3. In a transformer 21 which will be described in the present embodiment, shapes of a base part 22b and a base part 22c which are provided in a bobbin body 22 are different from the shapes of the base parts of the bobbin bodies provided in the transformer 1 and the transformer 11 which have been described in Embodiments 1 and 2.

FIG. 3 is a view illustrating a schematic configuration of the transformer 21 provided with the bobbin body 22 in which a hollow winding drum part 22a (the hollow winding drum part 22a is to include a base supporting a hollow winding drum), the base part 22b in which terminal parts 23a are formed, and the base part 22c in which terminal parts 23b are formed are integrated and PQ-type cores (a first core 25 and a second core 26).

FIG. 3(a) illustrates a plan view of the transformer 21, which is viewed from above, FIG. 3(b) illustrates a perspective view of the transformer 21, FIG. 3(c) illustrates a side view of the transformer 21, and FIG. 3(d) illustrates a plan view of the transformer 21 which is set so that the second core 26 is positioned in an upper side, which is viewed from above.

As illustrated in FIG. 3(a), in the bobbin body 22, the hollow winding drum part 22a, the base part 22b in which the terminal parts 23a are provided, and the base part 22c in which the terminal parts 23b are provided are integrated.

As illustrated in FIG. 3(b), the exposed core portions are generated also in the transformer 21 due to the above-described reason.

Moreover, as illustrated in FIG. 3(c), the base part 22b and the base part 22c which are formed integrally with the hollow winding drum part 22a respectively extend from opposite sides in a core part composed of the first core 25 and the second core 26 in the transformer 21.

For the transformer 21, as illustrated in FIG. 3(d), it is assumed that a voltage input from the terminal parts 23b in an input side (primary side) is converted into a predetermined voltage, and thereafter output from the terminal parts 23a in an output side (secondary side). When it is assumed that the core part composed of the first core 25 and the second core 26 has a primary-side potential, in terms of the necessary safety standard, it is necessary to secure a predetermined insulation distance from the exposed core portion A and the exposed core portion B for the terminal parts 23a, but it is not necessary to secure the predetermined insulation distance from the exposed core portion C or the exposed core portion D for the terminal parts 23b.

In the present embodiment, differently from a conventional configuration, the shape of the base part 22b is not formed in a shape in line symmetry with respect to a dotted line e-f in the drawing, which passes through the center of a line connecting the exposed core portion A and the exposed core portion B and is orthogonal to the line connecting the exposed core portion A and the exposed core portion B, as illustrated in FIG. 3(d).

That is, in the base part 22b, a portion which is closer to one region of the exposed core portion A (first region) and the exposed core portion B (second region) is notched. Note that, the present embodiment is described for a case where the portion which is closer to the exposed core portion A is notched.

Since the base part 22b is notched so that, for each of the terminal parts 23a provided in the base part 22b, a creepage distance from the exposed core portion A is always longer than a creepage distance from the exposed core portion B, it is necessary to secure an insulation distance (creepage distance on the base) only from the exposed core portion B, and an insulation distance (clearance) from the exposed core portion A may be secured so as to be short (it is not necessary to consider the insulation distance from the exposed core portion A).

As illustrated, the base part 22b extends in the vicinity of the exposed core portion B, but is notched in the vicinity of the exposed core portion A. Therefore, it is necessary to set a distance from the exposed core portion B to the closest terminal part 23a to be equal to or more than a predetermined value as a distance on the base part 22b. On the other hand, since it is possible to spatially secure insulation characteristics in the vicinity of the exposed core portion A with the notched part of the base part 22b, only the clearance of 4 mm is required to be secured as the insulation distance from the exposed core portion A.

Note that, the base part 22b has the shape which exists only in the vicinity of the exposed core portion B and does not exist in the vicinity of the exposed core portion A, so that it is possible to efficiently use a space in the vicinity of the exposed core portion A.

As above, in the base part 22b, it is possible to shorten a width in an up-and-down direction in the drawing, so that it is possible to attain space saving.

Thus, it is possible to realize the transformer 21 which secures an insulation property and is capable of further size reduction.

Furthermore, in the present embodiment, in order to realize further size reduction, differently from a conventional configuration, the shape of the base part 22c is not formed in a shape in line symmetry with respect to the dotted line e-f in the drawing, which passes through the center of a line connecting the exposed core portion C (third region) and the exposed core portion D (fourth region) and is orthogonal to the line connecting the exposed core portion C and the exposed core portion D, as illustrated in FIG. 3(d), either.

Specifically, as illustrated in FIG. 3(d), in the base part 22c, by bending a region in which the terminal part 23b which is the lowest in the drawing is formed toward a lower direction in the drawing, it is possible to suppress interference with other members such as, for example, a capacitor.

Note that, the shape of the base part 22c in the present embodiment is merely one example, and the shape is not particularly limited as long as interference with other members is able to be suppressed.

Thus, it is possible to realize the transformer 21 which secures an insulation property and is capable of further size reduction.

### Embodiment 4

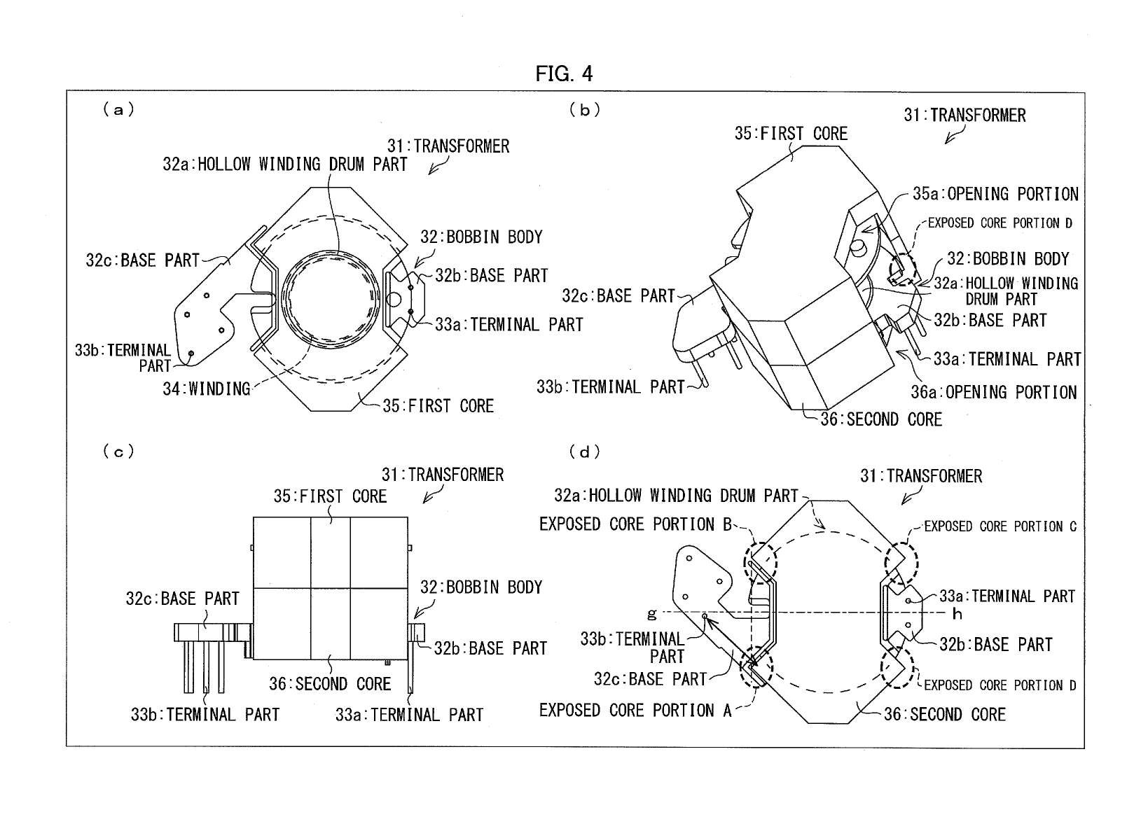

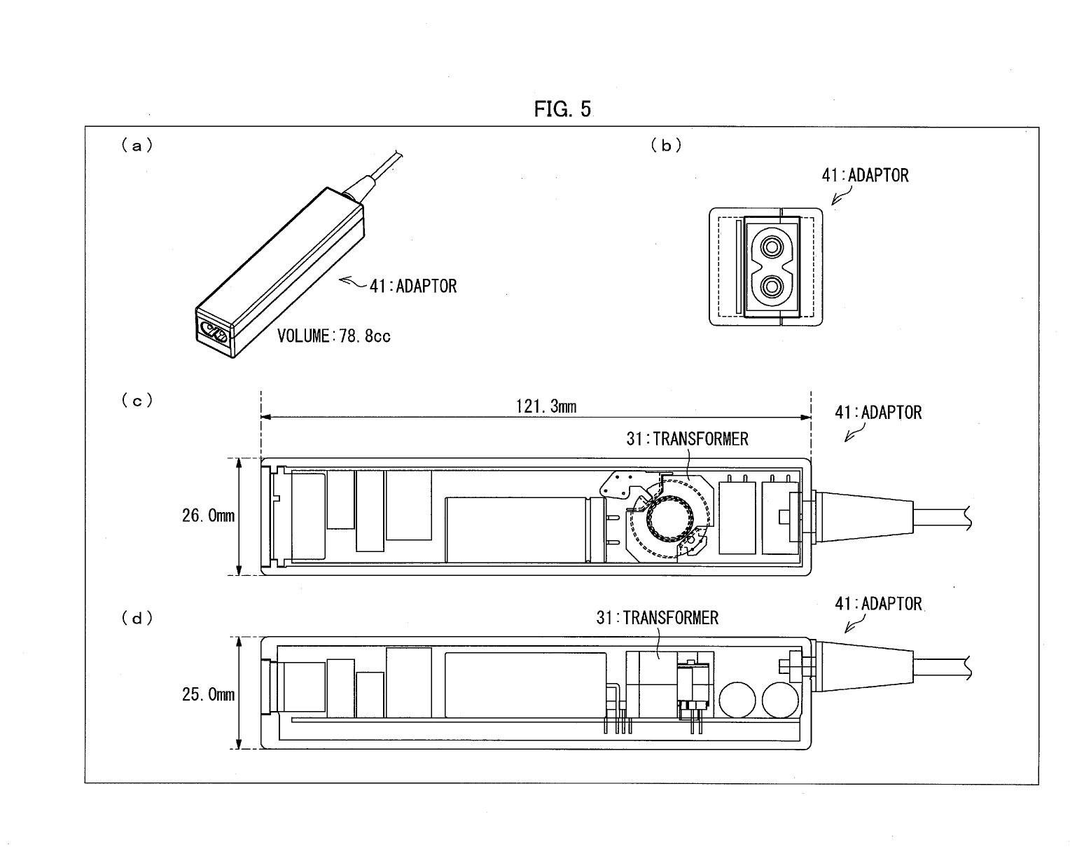

Next, the present embodiment 4 will be described with reference to FIG. 4 and FIG. 5. In a transformer 31 which will be described in the present embodiment, shapes of a base part 32b and a base part 32c which are provided in a bobbin body 32 are the same as the shapes of the base parts of the bobbin body provided in the transformer 1 which has been described in Embodiment 1, but the transformer 31 is different from the transformer 1 using the PQ-type cores, which has been described in Embodiment 1, in that cores are RM-type cores.

FIG. 4 is a view illustrating a schematic configuration of the transformer 31 provided with the bobbin body 32 in which a hollow winding drum part 32a (the hollow winding drum part 32a is to include a base supporting a hollow winding drum), the base part 32b in which terminal parts 33a are formed, and the base part 32c in which terminal parts 33b are formed are integrated and the RM-type cores (a first core 35 and a second core 36).

FIG. 4(a) illustrates a plan view of the transformer 31, which is viewed from above, FIG. 4(b) illustrates a perspective view of the transformer 31, FIG. 4(c) illustrates a side view of the transformer 31, and FIG. 4(d) illustrates a plan view of the transformer 31 which is set so that the second core 36 is positioned in an upper side, which is viewed from above.

The transformer 31 illustrated in FIG. 4 is different from the transformer 1 which has been described in Embodiment 1 by using FIG. 1 only in types of cores between the RM-type cores and the PQ-type cores.

The RM-type cores and the PQ-type cores are different in terms of the shapes of cores themselves as illustrated, and, accordingly, shapes of opening portions 35a and 36a are different.

As illustrated in FIG. 4(a), in the bobbin body 32, the hollow winding drum part 32a, the base part 32b in which the terminal parts 33a are provided, and the base part 32c in which the terminal parts 33b are provided are integrated.

As illustrated in FIG. 4(b), though the shapes of the opening portions 35a and 36a are different due to the RM-type cores, the exposed core portions are generated also in the transformer 31 due to the above-described reason.

Moreover, as illustrated in FIG. 4(c), the base part 32b and the base part 32c which are formed integrally with the hollow winding drum part 32a respectively extend from opposite sides in a core part composed of the first core 35 and the second core 36 in the transformer 31.

As illustrated in FIG. 4(d), four sites indicated with dotted-line circles in the drawing (exposed core portions A to D) are the exposed core portions, and the base part 32b formed integrally with the hollow winding drum part 32a is formed in line symmetry with respect to a dotted line g-h in the drawing. Then, for each of the terminal parts 33a formed in the base part 32b, it is not necessary to secure a predetermined insulation distance from the exposed core portion C or the exposed core portion D because of the following reason.

For the transformer 31, it is assumed that a voltage input from the terminal parts 33b in an input side (primary side) is converted into a predetermined voltage, and thereafter output from the terminal parts 33a in an output side (secondary side). When it is assumed that the core part composed of the first core 35 and the second core 36 has a secondary-side potential, in terms of the necessary safety standard, it is necessary to secure the predetermined insulation distance from the exposed core portion A and the exposed core portion B for the terminal parts 33b, but it is not necessary to secure the predetermined insulation distance from the exposed core portion C or the exposed core portion D for terminal parts 33a.

In the present embodiment, differently from a conventional configuration, the shape of the base part 32c is not formed in a shape in line symmetry with respect to the dotted line g-h in the drawing, which passes through the center of a line connecting the exposed core portion A and the exposed core portion B and is orthogonal to the line connecting the exposed core portion A and the exposed core portion B, as illustrated in FIG. 4(d).

That is, in the base part 32c, a portion which is closer to one region of the exposed core portion A (first region) and the exposed core portion B (second region) is notched. Note that, the present embodiment is described for a case where the portion which is closer to the exposed core portion B is notched.

Since the base part 32c is notched so that, for each of the terminal parts 33b provided in the base part 32c, a creepage distance from the exposed core portion B is always longer than a creepage distance from the exposed core portion A, it is necessary to secure an insulation distance (creepage distance along a surface of the base) only from the exposed core portion A, and it is necessary to provide only a clearance of 4 mm from the exposed core portion B.

As illustrated, the base part 32c extends in the vicinity of the exposed core portion A, but is notched in the vicinity of the exposed core portion B. Therefore, it is necessary to set a distance from the exposed core portion A to the closest terminal part 33b to be equal to or more than a predetermined value as a distance on the base part 32c. On the other hand, since insulation characteristics are able to be spatially secured in the vicinity of the exposed core portion B with the notched part of the base part 32c, it is possible to shorten a distance from the exposed core portion B to the closest terminal part 33b up to 4 mm.

For example, by securing, for example, about 7 mm for the distance on the base (creepage distance on the base) from the exposed core portion A to the closest terminal part 33b and securing, for example, about 4 mm for a spatial distance from the exposed core portion B to the closest terminal part 33b, it is possible to satisfy the safety standard, although these distances change in accordance with an input/output voltage. For example, when a shield of an insulator is arranged in a space through which a line obtained by connecting the exposed core portion B and the closest terminal part 33b with a straight line passes, it becomes possible to further shorten the clearance.

That is, from the exposed core portion B to the closest terminal part 33b in the base part 32c, the clearance may be secured so as to be short, so that it is possible to attain space saving.

As above, as for the base part 32c provided in the transformer 31 of the present embodiment, since it is necessary to consider only the insulation distance to the exposed core portion A, and it is not necessary to consider the creepage distance to the exposed core portion B, it is also possible to form a tip portion of the base part 32c in a shape approaching the exposed core portion B as illustrated in FIG. 4(d), thus making it possible to shorten a length of the base part 32c in a right-and-left direction in the drawing.

Thus, it is possible to realize the transformer 31 which secures an insulation property and is capable of further size reduction.

FIG. 5 is a view illustrating an adaptor 41 including the transformer 31 illustrated in FIG. 4

FIG. 5(a) illustrates a perspective view of the adaptor 41, FIG. 5(b) illustrates a view illustrating a shape of an input part of the adaptor 41, FIG. 5(c) illustrates a side view of the adaptor 41, and FIG. 5(d) illustrates a plan view of the adaptor 41.

As illustrated in FIG. 5(a), since the adaptor 41 is provided with the above-described transformer 31, a volume thereof is able to be 78.8 cc, which is smaller than a conventional one by about 10 cc.

Note that, as illustrated in FIG. 5(c) and FIG. 5(d), since the adaptor 41 has a height (longitudinal size) of 26.0 mm, a lateral width (lateral size) of 121.3 mm, and a depth (longitudinal size) of 25.0 mm, the volume thereof is 78.8 cc.

It is preferable that an aspect ratio of the aforementioned longitudinal sizes and the lateral size in the adaptor 41 is equal to or more than 1:3. In addition, in the adaptor 41 having such a long and thin shape, it is preferable that the RM-type core is provided. The RM-type core is able to have six side surfaces other than a side surface in which a first opening portion is formed and a side surface opposite to the side surface in which the first opening portion is formed, for example.

As illustrated in FIG. 5(c), since the base part 32c is formed in a shape which goes along one surface of a housing of the adaptor 41, which is a top surface of the housing of the adaptor 41 in the drawing in the present embodiment, it is possible to suppress interference with other members such as, for example, a capacitor. Such a shape of the base part 32c allows shortening the height and the lateral width of the adaptor 41, so that it is possible to reduce the volume of the adaptor 41 by about 10 cc compared with the conventional one.

As above, by using the transformer of the present embodiment, it is possible to realize further size reduction of a power source device including the transformer, such as an AC adaptor, for example.

### Embodiment 5

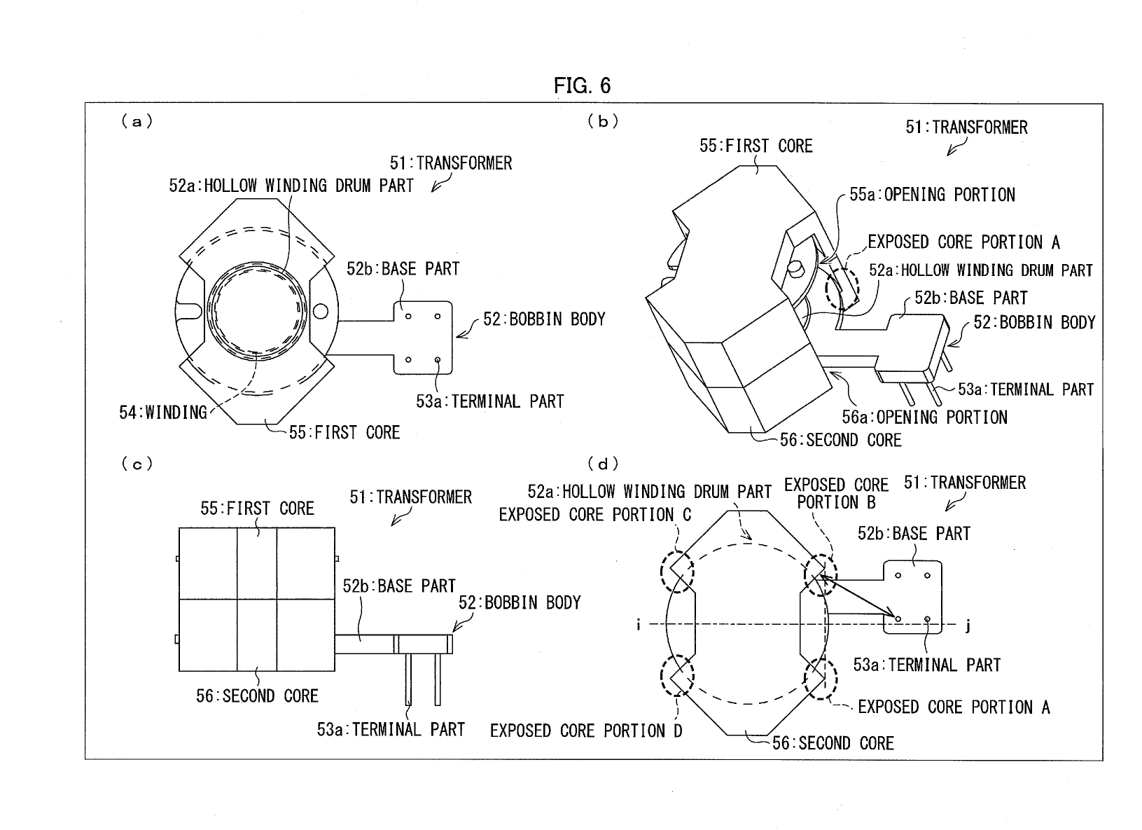

Next, the present embodiment 5 will be described with reference to FIG. 6. In a transformer 51 which will be described in the present embodiment, a shape of a base part 52b provided in a bobbin body 52 is the same as the shape of the base part of the bobbin body provided in the transformer 11 which has been described in Embodiment 2, but the transformer 51 is different from the transformer 11 using the PQ-type cores, which has been described in Embodiment 2, in that cores are RM-type cores.

FIG. 6 is a view illustrating a schematic configuration of the transformer 51 provided with the bobbin body 52 in which a hollow winding drum part 52a (the hollow winding drum part 52a is to include a base supporting a hollow winding drum) and the base part 52b in which terminal parts 53a are formed are integrated and the RM-type cores (a first core 55 and a second core 56).

FIG. 6(a) illustrates a plan view of the transformer 51, which is viewed from above, FIG. 6(b) illustrates a perspective view of the transformer 51, FIG. 6(c) illustrates a side view of the transformer 51, and FIG. 6(d) illustrates a plan view of the transformer 51 which is set so that the second core 56 is positioned in an upper side, which is viewed from above.

As illustrated in FIG. 6(a), in the bobbin body 52, the hollow winding drum part 52a and the base part 52b in which the terminal parts 53a are provided are integrated.

As illustrated in FIG. 6(b), the exposed core portions are generated also in the transformer 51 due to the above-described reason.

Moreover, as illustrated in FIG. 6(c), in the transformer 51, the base part 52b formed integrally with the hollow winding drum part 52a extends from one side of a core part composed of the first core 55 and the second core 56.

As illustrated in FIG. 6(d), for the transformer 51, it is assumed that a voltage input from terminal parts (not illustrated) in an input side (primary side) is converted into a predetermined voltage, and thereafter output from the terminal parts 53a in an output side (secondary side). When it is assumed that the core part composed of the first core 55 and the second core 56 has a primary-side potential, in terms of the necessary safety standard, it is necessary to secure a predetermined insulation distance from the exposed core portion A and the exposed core portion B for the terminal parts 53a.

In the present embodiment, differently from a conventional configuration, the shape of the base part 52b is not formed in a shape in line symmetry with respect to a dotted line i-j in the drawing, which passes through the center of a line connecting the exposed core portion A and the exposed core portion B and is orthogonal to the line connecting the exposed core portion A and the exposed core portion B, as illustrated in FIG. 6(d).

That is, in the base part 52b, a portion which is closer to one region of the exposed core portion A (first region) and the exposed core portion B (second region) is notched. Note that, the present embodiment is described for a case where the portion which is closer to the exposed core portion A is notched.

Since the base part 52b is notched so that, for each of the terminal parts 53a provided in the base part 52b, a creepage distance from the exposed core portion A is always longer than a creepage distance from the exposed core portion B, it is necessary to secure an insulation distance (creepage distance along a surface of the base) only from the exposed core portion B, and it is necessary to secure only a necessary clearance from the exposed core portion A.

As illustrated, the base part 52b extends in the vicinity of the exposed core portion B, but is notched in the vicinity of the exposed core portion A. Therefore, it is necessary to set a distance from the exposed core portion B to the closest terminal part 53a to be equal to or more than a predetermined value as a distance on the base part 52b. On the other hand, since it is possible to spatially secure insulation characteristics in the vicinity of the exposed core portion A with the notched part of the base part 52b, it is possible to shorten a safety distance from the exposed core portion A compared with a conventional example for which a creepage distance needs to be taken into consideration.

Note that, the base part 52b exists only in the vicinity of the exposed core portion B and does not exist in the vicinity of the exposed core portion A, so that it is possible to efficiently use a space in the vicinity of the exposed core portion A.

As above, in the base part 52b, it is possible to shorten a width in an up-and-down direction in the drawing, so that it is possible to attain space saving.

Thus, it is possible to realize the transformer 51 which secures an insulation property and is capable of further size reduction.

### Embodiment 6

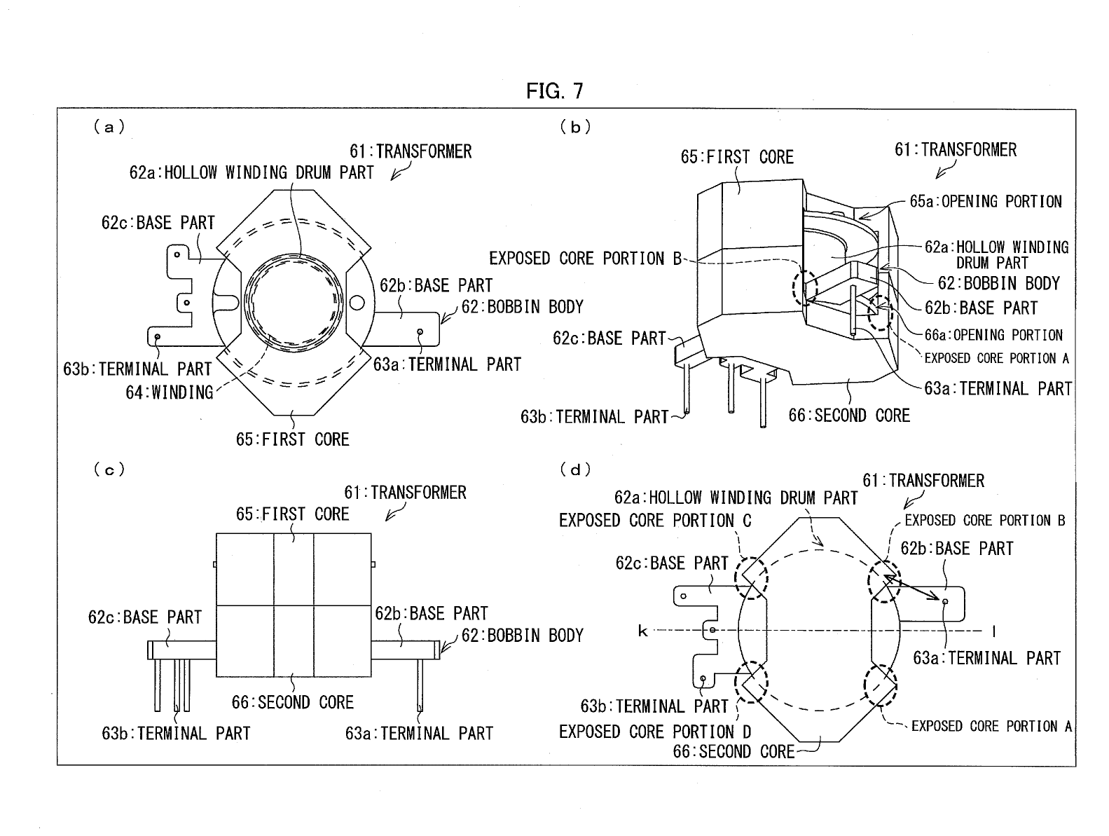

Next, the present embodiment 6 will be described with reference to FIG. 7. In a transformer 61 which will be described in the present embodiment, shapes of a base part 62b and a base part 62c which are provided in a bobbin body 62 are the same as the shapes of the base parts of the bobbin body provided in the transformer 21 which has been described in Embodiment 3, but the transformer 61 is different from the transformer 21 using the PQ-type cores, which has been described in Embodiment 3, in that cores are RM-type cores.

FIG. 7 is a view illustrating a schematic configuration of the transformer 61 provided with the bobbin body 62 in which a hollow winding drum part 62a (the hollow winding drum part 62a is to include a base supporting a hollow winding drum), the base part 62b in which a terminal part 63a is formed, and the base part 62c in which terminal parts 63b are formed are integrated and the RM-type cores (a first core 65 and a second core 66).

FIG. 7(a) illustrates a plan view of the transformer 61, which is viewed from above, FIG. 7(b) illustrates a perspective view of the transformer 61, FIG. 7(c) illustrates a side view of the transformer 61, and FIG. 7(d) illustrates a plan view of the transformer 61 which is set so that the second core 66 is positioned in an upper side, which is viewed from above.

As illustrated in FIG. 7(a), in the bobbin body 62, the hollow winding drum part 62a, the base part 62b in which the terminal part 63a is provided, and the base part 62c in which the terminal parts 63b are provided are integrated.

As illustrated in FIG. 7(b), the exposed core portions are generated also in the transformer 61 due to the above-described reason.

Moreover, as illustrated in FIG. 7(c), the base part 62b and the base part 62c which are formed integrally with the hollow winding drum part 62a respectively extend from opposite sides in a core part composed of the first core 65 and the second core 66 in the transformer 61.

For the transformer 61, as illustrated in FIG. 7(d), it is assumed that a voltage input from the terminal parts 63b in an input side (primary side) is converted into a predetermined voltage, and thereafter output from the terminal part 63a in an output side (secondary side). When it is assumed that the core part composed of the first core 65 and the second core 66 has a primary-side potential, in terms of the necessary safety standard, it is necessary to secure a predetermined insulation distance from the exposed core portion A and the exposed core portion B for the terminal part 63a, but it is not necessary to secure the predetermined insulation distance from the exposed core portion C or the exposed core portion D for the terminal parts 63b.

In the present embodiment, differently from a conventional configuration, the shape of the base part 62b is not formed in a shape in line symmetry with respect to a dotted line k−1 in the drawing, which passes through the center of a line connecting the exposed core portion A and the exposed core portion B and is orthogonal to the line connecting the exposed core portion A and the exposed core portion B, as illustrated in FIG. 7(d).

That is, in the base part 62b, a portion which is closer to one region of the exposed core portion A (first region) and the exposed core portion B (second region) is notched. Note that, the present embodiment is described for a case where the portion which is closer to the exposed core portion A is notched.

Since the base part 62b is notched so that, for each terminal part 63a provided in the base part 62b, a creepage distance from the exposed core portion A is always longer than a creepage distance from the exposed core portion B, it is necessary to secure an insulation distance (creepage distance along a surface of the base) only from the exposed core portion B, and it is necessary to secure only a clearance of 4 mm from the exposed core portion A.

As illustrated, the base part 62b extends in the vicinity of the exposed core portion B, but is notched in the vicinity of the exposed core portion A. Therefore, it is necessary to set a distance from the exposed core portion B to the closest terminal part 63a to be equal to or more than a predetermined value (7 mm) as a distance on the base part 62b. On the other hand, since it is possible to spatially secure insulation characteristics in the vicinity of the exposed core portion A with the notched part of the base part 62b, an insulation distance from the exposed core portion A may be secured so as to be short (4 mm).

Note that, the base part 62b has the shape which exists only in the vicinity of the exposed core portion B and does not exist in the vicinity of the exposed core portion A, so that it is possible to efficiently use a space in the vicinity of the exposed core portion A.

As above, in the base part 62b, it is possible to shorten a width in an up-and-down direction in the drawing, so that it is possible to attain space saving.

Thus, it is possible to realize the transformer 21 which secures an insulation property and is capable of further size reduction.

Furthermore, in the present embodiment, in order to realize further size reduction, differently from a conventional configuration, the shape of the base part 62c is not formed in a shape in line symmetry with respect to the dotted line k−1 in the drawing, which passes through the center of a line connecting the exposed core portion C (third region) and the exposed core portion D (fourth region) and is orthogonal to the line connecting the exposed core portion C and the exposed core portion D, as illustrated in FIG. 7(d), either.

Specifically, as illustrated in FIG. 7(d), in the base part 62c, by bending a region in which the terminal part 63b which is the lowest in the drawing is formed toward a lower direction in the drawing, it is possible to suppress interference with other members such as, for example, a capacitor.

Note that, the shape of the base part 62c in the present embodiment is merely one example, and the shape is not particularly limited as long as interference with other members is able to be suppressed. Though only one terminal part 63a is illustrated, there may be a plurality of terminal parts 63a.

Thus, it is possible to realize the transformer 61 which secures an insulation property and is capable of further size reduction.

### Embodiment 7

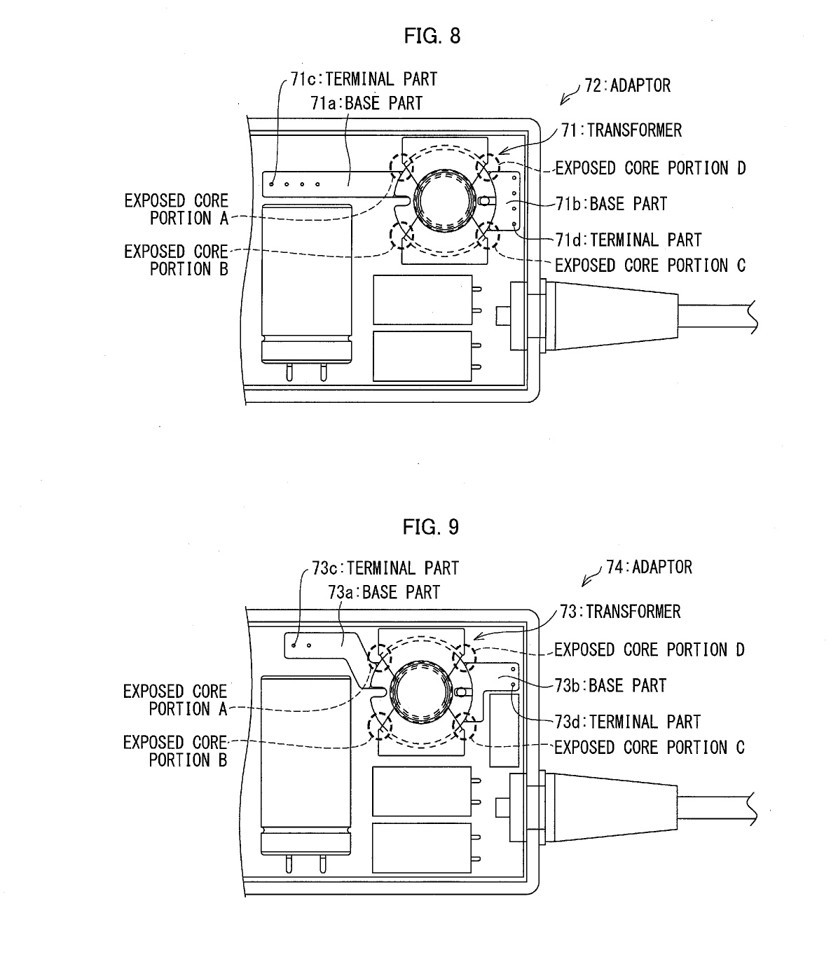

Next, the present embodiment 7 will be described with reference to FIG. 8. In an adaptor 72 which will be described in the present embodiment, a transformer 71 having a PQ-type core part is provided, and the transformer 71 is the same as the transformer 21 which has been described in Embodiment 3 except shapes of base parts extending to an outside from the core part.

FIG. 8 is a view illustrating a schematic configuration of the adaptor 72 including the transformer 71 having the PQ-type core part.

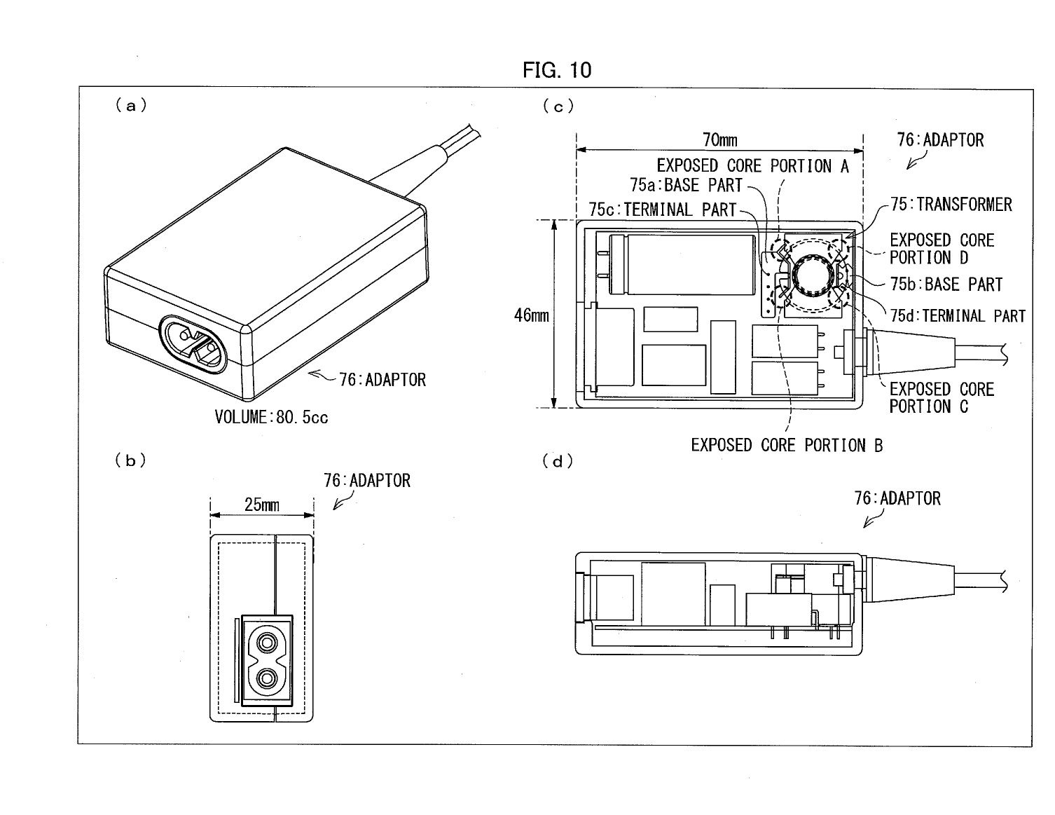

As illustrated, the adaptor 72 is a matchbox-shaped adaptor, whose overall size is substantially the same as that of FIG. 10.

For the transformer 71, as illustrated, it is assumed that a voltage input from terminal parts 71c in an input side (primary side) is converted into a predetermined voltage, and thereafter output from terminal parts 71d in an output side (secondary side). When it is assumed that the core part has a secondary-side potential, in terms of the necessary safety standard, it is necessary to secure a predetermined insulation distance from the exposed core portion A and the exposed core portion B for the terminal parts 71c, but it is not necessary to secure the predetermined insulation distance from the exposed core portion C or the exposed core portion D for the terminal parts 71d.

Accordingly, it is not necessary to secure the predetermined insulation distance from the exposed core portion C or the exposed core portion D for the terminal parts 71d of a base part 71b, and a length of the base part 71b may be short, so that a base having a shape similar to that of a conventional one may be used.

On the other hand, differently from a shape of a conventional base, the base part 71a extending to the outside from the core part in the transformer 71 (base in a left side in the drawing) is not formed in a shape in line symmetry with respect to a line which passes through the center of a line connecting the exposed core portion A and the exposed core portion B and is orthogonal to the line connecting the exposed core portion A and the exposed core portion B.

That is, in the base part 71a, a portion which is closer to one region of the exposed core portion A (first region) and the exposed core portion B (second region) is notched. Note that, the present embodiment is described for a case where the portion which is closer to the exposed core portion B is notched.

Since the base part 71a is notched so that, for each of the terminal parts 71c provided in the base part 71a, a creepage distance from the exposed core portion B is always longer than a creepage distance from the exposed core portion A, it is necessary to secure an insulation distance (creepage distance on the base) only from the exposed core portion A for the terminal parts 71c, and it is necessary to secure only a clearance of 4 mm from the exposed core portion B. When a shield of an insulator, which is not illustrated, is arranged on the way of a path obtained by connecting the exposed core portion B and the terminal part 71c with a straight line, it becomes possible to further shorten a clearance from the exposed core portion B to the terminal part 71c (for example, so as to be 1 mm).

Furthermore, the base part 71a is formed in a linear shape as illustrated, so that it is possible to suppress interference with other members such as, for example, a capacitor.

That is, since the base part 71a exists only in a vicinity of the exposed core portion A and does not exist in a vicinity of the exposed core portion B, it is possible to efficiently use a space in the vicinity of the exposed core portion B.

Moreover, the base part 71a has an advantage to go along an upper side of a matchbox-housing, and an end part of the base part 71b, which is in a right end in the drawing, has an advantage to go along a right side of the matchbox-housing. The transformer 71 is able to be arranged in a vacancy of the housing in this manner, so that it is possible to effectively use an inner space which is limited due to size reduction.

Note that, though it is preferable to use the transformer 71 having the PQ-type core part for the matchbox-shaped adaptor 72, a transformer having an RM-type core part may be used.

The shape of the base part 71a in the present embodiment is merely one example, and the shape is not particularly limited as long as interference with other members is able to be suppressed.

As above, by using the transformer 71 of the present embodiment, it is possible to realize further size reduction of the adaptor 72 including the transformer 71.

### Embodiment 8

Next, the present embodiment 8 will be described with reference to FIG. 9. In an adaptor 74 which will be described in the present embodiment, a transformer 73 having a PQ-type core part is provided, and the transformer 73 is the same as the transformer 71 which has been described in Embodiment 7 except shapes of base parts extending to an outside from the core part.

FIG. 9 is a view illustrating a schematic configuration of the adaptor 74 including the transformer 73 having the PQ-type core part.

As illustrated, the adaptor 74 is a matchbox-shaped adaptor, whose overall size is substantially the same as that of FIG. 10.

For the transformer 73, as illustrated, it is assumed that a voltage input from terminal parts 73c in an input side (primary side) is converted into a predetermined voltage, and thereafter output from terminal parts 73d in an output side (secondary side). When it is assumed that the core part has a secondary-side potential, in terms of the necessary safety standard, it is necessary to secure a predetermined insulation distance from the exposed core portion A and the exposed core portion B for the terminal parts 73b, but it is not necessary to secure the predetermined insulation distance from the exposed core portion C or the exposed core portion D for the terminal parts 73d.

However, in the present embodiment, in order to realize further size reduction, differently from a conventional configuration, a shape of a base part 73b in which the terminal parts 73d are provided is not formed in a shape in line symmetry with respect to a line which passes through the center of a line connecting the exposed core portion C (third region) and the exposed core portion D (fourth region) and is orthogonal to the line connecting the exposed core portion C and the exposed core portion D, either.

Specifically, as illustrated, in the base part 73b, a portion which is closer to one region of the exposed core portion C (third region) and the exposed core portion D (fourth region) is notched. Note that, the present embodiment is described for a case where the portion which is closer to the exposed core portion C is notched. It is therefore possible to suppress interference of the base part 73b with other members such as a capacitor.

The shape of the base part 73b in the present embodiment is merely one example, and the shape is not particularly limited as long as interference with other members is able to be suppressed.

In addition, in the transformer 73, differently from a shape of a conventional base, the base part 73a extending to the outside from the core part (base in a left side in the drawing) is not formed in a shape in line symmetry with respect to a line which passes through the center of a line connecting the exposed core portion A and the exposed core portion B and is orthogonal to the line connecting the exposed core portion A and the exposed core portion B, either.

That is, in the base part 73a, a portion which is closer to one region of the exposed core portion A (first region) and the exposed core portion B (second region) is notched. Note that, the present embodiment is described for a case where the portion which is closer to the exposed core portion B is notched.

Since the base part 73a is notched so that, for each of the terminal parts 73c provided in the base part 73a, a creepage distance from the exposed core portion B is always longer than a creepage distance from the exposed core portion A, it is necessary to secure a creepage distance only from the exposed core portion A for the terminal parts 73b, and it is necessary to secure only a clearance (4 mm) from the exposed core portion B.

Further, as illustrated, since the base part 73a is formed in a linear shape which goes along one surface of a housing of the adaptor 74, which is a top or bottom surface of the housing of the adaptor 74 in the drawing in the present embodiment, and is bent in a portion close to the core part in a direction of an upper-side surface of the housing of the adaptor 74 in the drawing, it is possible to suppress interference with other members such as, for example, a capacitor.

That is, the base part 73a exists only in a vicinity of the exposed core portion A and does not exist in a vicinity of the exposed core portion B, so that it is possible to efficiently use a space in the vicinity of the exposed core portion B.

The shape of the base part 73a in the present embodiment is merely one example, and the shape is not particularly limited as long as interference with other members is able to be suppressed.

As above, by using the transformer 73 of the present embodiment, it is possible to realize further size reduction of the adaptor 74 including the transformer 73.

Note that, though description has been given in the present embodiment by taking, as an example, the transformer 73 having the PQ-type core part, a transformer having an RM-type core part may be used.

Moreover, the base part 73a has an advantage to go along an upper side of a matchbox-housing, and an end part of the base part 73b, which is in a right end in the drawing, has an advantage to go along a right side of the matchbox-housing. The transformer 73 is able to be arranged in a vacancy of the housing in this manner, so that it is possible to effectively use an inner space which is limited due to size reduction.

Note that, though it is preferable to use the transformer 73 having the PQ-type core part for the matchbox-shaped adaptor 74, a transformer having an RM-type core part may be used.

### Embodiment 9

Next, the present embodiment 9 will be described with reference to FIG. 10. In an adaptor 76 which will be described in the present embodiment, a transformer 75 having a PQ-type core part is provided, and the transformer 75 is the same as the transformer 71 which has been described in Embodiment 7 except shapes of base parts extending to an outside from the core part.

FIG. 10 is a view illustrating the adaptor 76 including the transformer 75.

FIG. 10(a) illustrates a perspective view of the adaptor 76, FIG. 10(b) illustrates a view illustrating a shape of an input part of the adaptor 76, FIG. 10(c) illustrates a plan view of the adaptor 76, and FIG. 10(d) illustrates a side view of the adaptor 41.

As illustrated in FIG. 10(c), in the transformer 75, differently from a shape of a conventional base, a base part 75a extending to the outside from the core part (base in a left side in the drawing) is not formed in a shape in line symmetry with respect to a line which passes through the center of a line connecting the exposed core portion A and the exposed core portion B and is orthogonal to the line connecting the exposed core portion A and the exposed core portion B.

That is, in the base part 75a, a portion which is closer to one region of the exposed core portion A (first region) and the exposed core portion B (second region) is notched. Note that, the present embodiment is described for a case where the portion which is closer to the exposed core portion B is notched.

Since the base part 75a is notched so that, for each of terminal parts 75c provided in the base part 75a, a creepage distance from the exposed core portion B is always longer than a creepage distance from the exposed core portion A, it is necessary to secure a creepage distance on the base only from the exposed core portion A for the terminal parts 75c, and it is necessary to secure only a clearance from the exposed core portion B.

The base part 75a is formed in a linear shape so as to go along surfaces in right and left sides of a housing of the adaptor 76 in the drawing, and extends only in a vicinity of the exposed core portion A, so that it is possible to suppress interference with other members such as, for example, a capacitor, and effectively use a limited space in the housing.

As illustrated in FIG. 10(a), the adaptor 76 is a matchbox-shaped adaptor.

For the transformer 75 illustrated in FIG. 10(c), it is assumed that a voltage input from terminal parts 75c in an input side (primary side) is converted into a predetermined voltage, and thereafter output from terminal parts 75d in an output side (secondary side). When it is assumed that the core part has a secondary-side potential, in terms of the necessary safety standard, it is necessary to secure a predetermined insulation distance from the exposed core portion A and the exposed core portion B for the terminal parts 75c, but it is not necessary to secure the predetermined insulation distance from the exposed core portion C or the exposed core portion D for the terminal parts 75d.

Accordingly, it is not necessary to secure the predetermined insulation distance from the exposed core portion C or the exposed core portion D for the terminal parts 75d of a base part 75b, and a length of the base part 75b may be short, so that a base having a shape similar to that of a conventional one may be used.

As illustrated in FIG. 10(a), since the adaptor 76 is provided with the above-described transformer 75, a volume thereof is able to be 80.5 cc, which is smaller than a conventional one.

Note that, as illustrated in FIG. 10(b) and FIG. 10(c), since the adaptor 76 has a height (longitudinal size) of 25.0 mm, a lateral width (lateral size) of 70.0 mm, and a depth (longitudinal size) of 46.0 mm, the volume thereof is 80.5 cc.

It is preferable that an aspect ratio of the aforementioned longitudinal sizes and the lateral size in the adaptor 76 is equal to or less than 1:3. In addition, in the adaptor 76 having such a matchbox shape, it is preferable that the PQ-type core is provided. The PQ-type core is able to have two opposite side surfaces other than a side surface in which a first opening portion is formed and a side surface opposite to the side surface in which the first opening portion is formed.

As illustrated in FIG. 10(c), the shape of the base part 75a provided in the transformer 75 allows shortening the lateral width of the adaptor 76, so that it is possible to reduce the volume of the adaptor 76 compared with the conventional one.

As above, by using the transformer of the present embodiment, it is possible to realize further size reduction of a power source device including the transformer, such as an AC adaptor, for example.

In a case where a potential of the core part is designed to be a primary-side potential, the way of notching the base part 75b may be devised. In a case where a potential of the core part is in a floating state (both of a primary-side potential and a secondary-side potential are insulated), a notch may be designed for each of the base parts 75a and 75b.

Moreover, the base part 75a has an advantage to go along an upper side of the matchbox-housing, and an end part of the base part 75b, which is in a right end in the drawing, has an advantage to go along a right side of the matchbox-housing. The transformer 75 is able to be arranged in a vacancy of the housing in this manner, so that it is possible to effectively use an inner space which is limited due to size reduction.

The power source device in which the base part 75a is formed so as to be substantially perpendicular to an inner wall of the housing (inner walls of upper and lower sides in the drawing) in a direction from a region including the notched part to a region not including the notched part.

Note that, though it is preferable to use the transformer 75 having the PQ-type core part for the matchbox-shaped adaptor 76, a transformer having an RM-type core part may be used.

### Embodiment 10

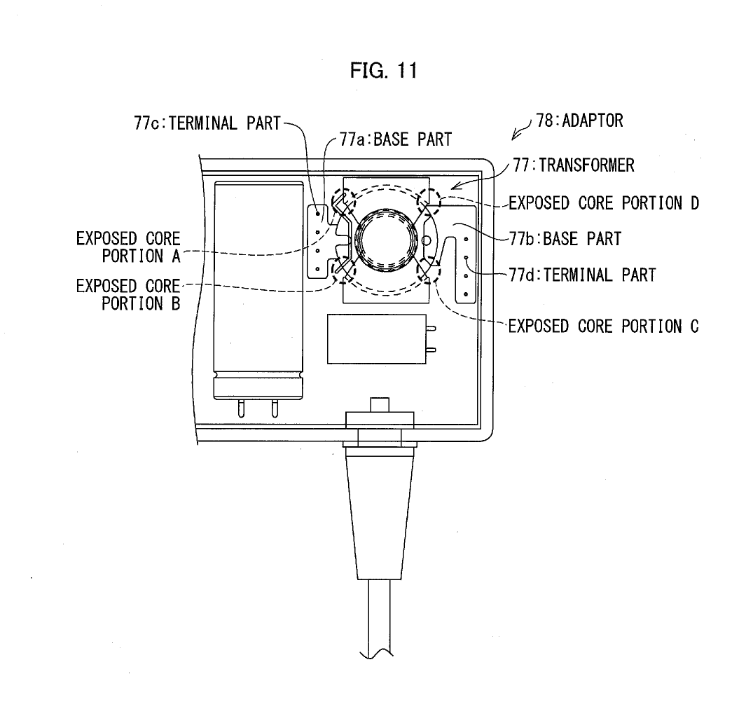

Next, the present embodiment 10 will be described with reference to FIG. 11. In an adaptor 78 which will be described in the present embodiment, a transformer 77 having a PQ-type core part is provided, and the transformer 77 is the same as the transformer 71 which has been described in Embodiment 7 except shapes of base parts extending to an outside from the core part.

FIG. 11 is a view illustrating the matchbox-shaped adaptor 78 including the transformer 77.

For the transformer 77 which is illustrated, it is assumed that a voltage input from terminal parts 77c in an input side (primary side) is converted into a predetermined voltage, and thereafter output from terminal parts 77d in an output side (secondary side). When it is assumed that the core part has a primary-side potential, in terms of the necessary safety standard, it is necessary to secure a predetermined insulation distance from the exposed core portion C and the exposed core portion D for the terminal parts 77d, but it is not necessary to secure the predetermined insulation distance from the exposed core portion A or the exposed core portion B for the terminal parts 77c.

Accordingly, it is not necessary to secure the predetermined insulation distance from the exposed core portion A or the exposed core portion B for the terminal parts 77c of a base part 77a, and a length of the base part 77a is short, so that a base having a shape similar to that of a conventional one may be used.

As illustrated, in the transformer 77, differently from a shape of a conventional base, a base part 77b extending to the outside from the core part (base in a right side in the drawing) is not formed in a shape in line symmetry with respect to a line which passes through the center of a line connecting the exposed core portion C and the exposed core portion D and is orthogonal to the line connecting the exposed core portion C and the exposed core portion D.

That is, in the base part 77b, a portion which is closer to one region of the exposed core portion C (first region) and the exposed core portion D (second region) is notched. Note that, the present embodiment is described for a case where the portion which is closer to the exposed core portion C is notched.

Since the base part 77b is notched so that, for each of the terminal parts 77d provided in the base part 77b, a creepage distance from the exposed core portion C is always longer than a creepage distance from the exposed core portion D, it is necessary to secure a creepage distance on the base only from the exposed core portion D for the terminal parts 77d, and it is necessary to secure only a clearance (4 mm) from the exposed core portion C.

The base part 77b is formed in a linear shape so as to go along surfaces in right and left sides of a housing of the adaptor 78 in the drawing, and extends only in a vicinity of the exposed core portion D, so that it is possible to suppress interference with other members such as, for example, a capacitor, and use a limited inner space of the housing.

Accordingly, the shape of the base part 77b provided in the transformer 77 allows shortening a lateral width of the adaptor 78, so that it is possible to reduce a volume of the adaptor 78 compared with the conventional one.

As above, by using the transformer of the present embodiment, it is possible to realize further size reduction of a power source device including the transformer, such as an AC adaptor, for example.

Note that, though description has been given in the present embodiment by taking, as an example, the transformer 77 having the PQ-type core part, a transformer having an RM-type core part may be used.

Moreover, the base part 77a has an advantage to go along an upper side of the matchbox-housing, and an end part of the base part 77b, which is in a right end in the drawing, has an advantage to go along a right side of the matchbox-housing. The transformer 77 is able to be arranged in a vacancy of the housing in this manner, so that it is possible to effectively use the inner space which is limited due to size reduction.

Note that, though it is preferable to use the transformer 77 having the PQ-type core part for the matchbox-shaped adaptor 78, a transformer having an RM-type core part may be used.

### Embodiment 11

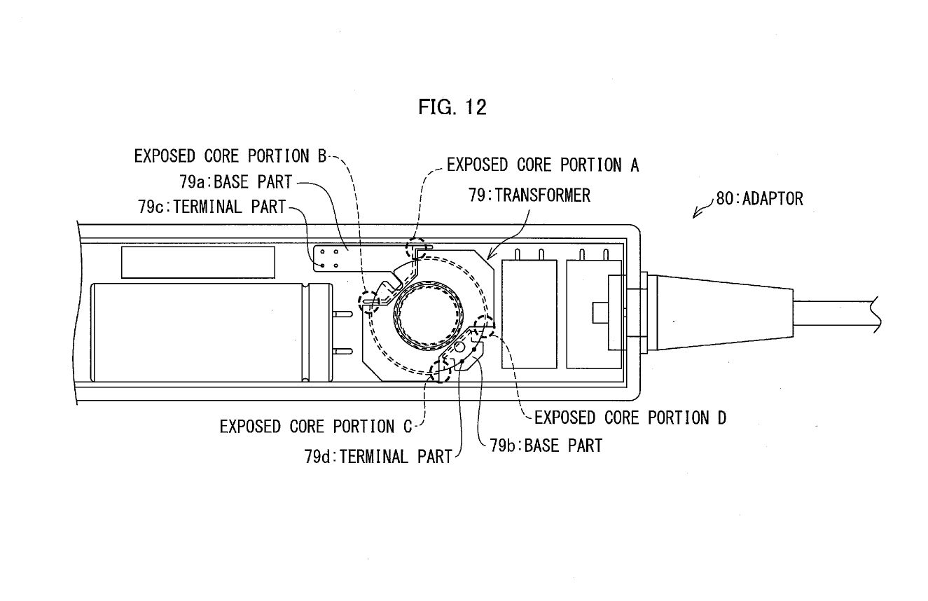

Next, the present embodiment 11 will be described with reference to FIG. 12. In an adaptor 80 which will be described in the present embodiment, a transformer 79 having an RM-type core part is provided, and the transformer 79 is the same as the transformer 41 which has been described in Embodiment 4 except shapes of base parts extending to an outside from the core part.

FIG. 12 is a view illustrating the adaptor 80 having a long and thin shape, which is provided with the transformer 79.

For the transformer 77 which is illustrated, it is assumed that a voltage input from terminal parts 79c in an input side (primary side) is converted into a predetermined voltage, and thereafter output from terminal parts 79d in an output side (secondary side). When it is assumed that the core part has a secondary-side potential, in terms of the necessary safety standard, it is necessary to secure a predetermined insulation distance from the exposed core portion A and the exposed core portion B for the terminal parts 79c, but it is not necessary to secure the predetermined insulation distance from the exposed core portion C or the exposed core portion D for the terminal parts 79d.

Accordingly, it is not necessary to secure the predetermined insulation distance from the exposed core portion C or the exposed core portion D for the terminal parts 79d of a base part 79b, and a length of the base part 79b is short, so that a base having a shape similar to that of a conventional one may be used.

As illustrated, in the transformer 79, differently from a shape of a conventional base, a base part 79a extends to the outside from the core part (base in a left side in the drawing) is not formed in a shape in line symmetry with respect to a line which passes through the center of a line connecting the exposed core portion A and the exposed core portion B and is orthogonal to the line connecting the exposed core portion A and the exposed core portion B.

That is, in the base part 79a, a portion which is closer to one region of the exposed core portion A (first region) and the exposed core portion B (second region) is notched. Note that, the present embodiment is described for a case where the portion which is closer to the exposed core portion B is notched.

Since the base part 79a is notched so that, for each of the terminal parts 79c provided in the base part 79a, a creepage distance from the exposed core portion B is always longer than a creepage distance from the exposed core portion A, it is necessary to secure an insulation distance (creepage distance on the base) only from the exposed core portion A for the terminal parts 79c, and it is necessary to secure only a clearance from the exposed core portion B.

Since the base part 79a is formed in a linear shape which goes along one surface of a housing of the adaptor 80, which is a top surface thereof in the drawing in the present embodiment, and extends only in a vicinity of the exposed core portion A, it is possible to suppress interference with other members such as, for example, a capacitor, and effectively use a long and thin space.

Accordingly, the shape of the base part 79a provided in the transformer 80 allows reducing a volume of the adaptor 80 compared with the conventional one.

As above, by using the transformer of the present embodiment, it is possible to realize further size reduction of a power source device including the transformer, such as an AC adaptor, for example.

Moreover, the base part 79a has an advantage to go along an upper side of the housing having the long and thin shape. The transformer 79 is able to be arranged in a vacancy of the housing in this manner, so that it is possible to effectively use an inner space which is limited due to size reduction.

Note that, though it is preferable to use the transformer 79 having the RM-type core part for the adaptor 80 having the long and thin shape, a transformer having a PQ-type core part may be used.

### Embodiment 12

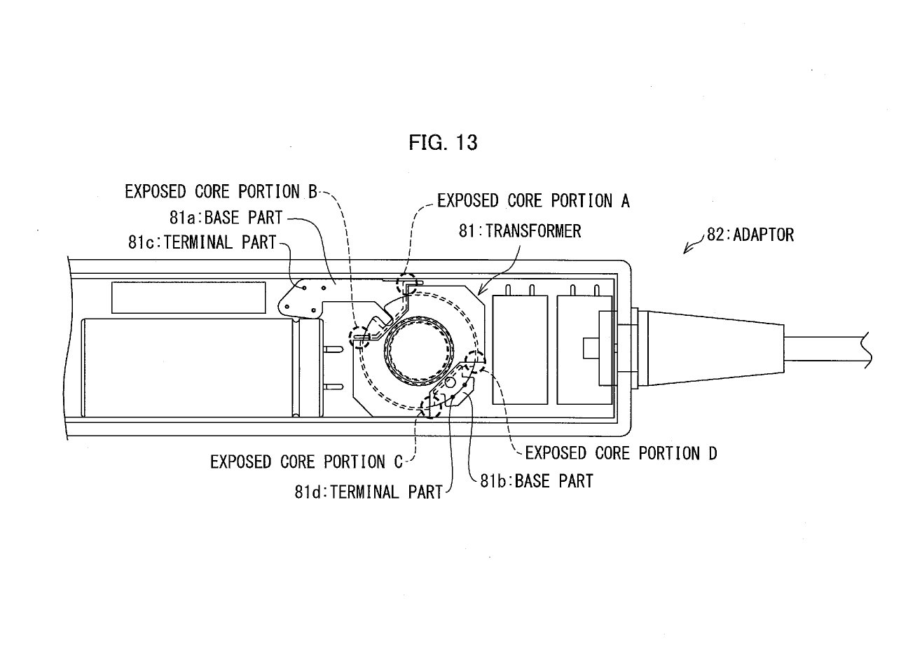

Next, the present embodiment 12 will be described with reference to FIG. 13. In an adaptor 82 which will be described in the present embodiment, a transformer 81 having an RM-type core part is provided, and the transformer 81 is the same as the transformer 41 which has been described in Embodiment 4 except a shape of a base part 81a extending to an outside from the core part.

FIG. 13 is a view illustrating the adaptor 82 having a long and thin shape, which is provided with the transformer 81.

A difference between the shape of the base part 81a provided in the transformer 81 and the shape of the base part 32c provided in the transformer 41 which has been described in Embodiment 4 (illustrated in FIG. 4) is as follows.

The base part 81a is formed so as to go along one surface of a housing of the adaptor 82, which is a top surface of the housing of the adaptor 82 in the drawing in the present embodiment, and so as to be longer than a base pert 32c.

Note that, the base part 81a has a shape which exists only in a vicinity of the exposed core portion A and does not exist in a vicinity of the exposed core portion B, so that it is possible to efficiently use a space in the vicinity of the exposed core portion B.

Accordingly, it is possible to arrange other members such as a capacitor in a portion lower than the base part 81a, thus making it possible to reduce a volume of the adaptor 82 compared with a conventional one.

As above, by using the transformer of the present embodiment, it is possible to realize further size reduction of a power source device including the transformer, such as an AC adaptor, for example.

Moreover, the base part 81a has an advantage to go along an upper side of the housing having the long and thin shape. The transformer 81 is able to be arranged in a vacancy of the housing in this manner, so that it is possible to effectively use an inner space which is limited due to size reduction.

Note that, though it is preferable to use the transformer 81 having the RM-type core part for the adaptor 82 having the long and thin shape, a transformer having a PQ-type core part may be used.

### Embodiment 13

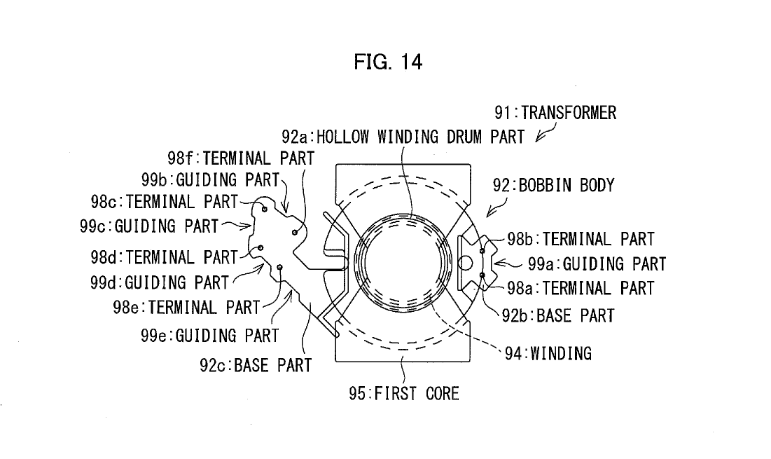

Next, the present embodiment 13 will be described base on FIG. 14. In a transformer 91 which will be described in the present embodiment, shapes of a base part 92b and base part 92c which are provided in a bobbin body 92 are different from the shapes of the base parts 2b and 2c of the bobbin body provided in the transformer 1 which has been described in Embodiment 1. A base which is provided in the transformer 91 and includes a hollow winding drum part 92a (the hollow winding drum part 92a is to include a base supporting a hollow winding drum), the base part 92b, and the base part 92c is provided with guiding parts 99a, 99b, 99c, 99d, and 99e by which windings 94 wound around the hollow winding drum part 92a are drawn to a surface of the base, which is opposite to a surface in which the hollow winding drum part 92a is formed.

FIG. 14 illustrates a plan view of the transformer 91 provided with the bobbin body 92 in which the hollow winding drum part 92a, the base part 92b in which terminal parts 98a and 98b are formed, and the base part 92c in which terminal parts 98c, 98d, 98e, and 98f are formed are integrated and PQ-type cores (a first core 95 and a second core (not illustrated)), which is viewed from above.

As illustrated in FIG. 14, the base part 92b is provided with the guiding part 99a, and the guiding part 99a is formed by notching the base part 92b. In a process of producing the transformer 91, the windings 94 such as, for example, copper wires, which are wound around the hollow winding drum part 92a, are wound around the terminal parts 98a and 98b which are provided in the surface of the base, which is opposite to the surface in which the hollow winding drum part 92a is formed, and fixed with solder. At a time of winding down the windings 94 from the hollow winding drum part 92a to the terminal parts 98a and 98b, that is, at a time of drawing the windings 94 from the hollow winding drum part 92a provided in a top surface of the base to the terminal parts 98a and 98b provided in a bottom surface which is a surface opposite to the top surface of the base, by arranging the windings 94 so as to go along the guiding part 99a, it is possible to stably perform the above-described soldering work. This is because the guiding part 99a has a function of fixing a drawing position of the windings 94 which have been wound, and it becomes possible to improve productivity of the transformer by including the guiding part 99a.

Similarly, as illustrated in FIG. 14, the base part 92c is provided with the guiding parts 99b, 99c, 99d, and 99e, and the guiding parts 99b, 99c, 99d, and 99e are formed by notching the base part 92c. Since the guiding parts 99b, 99c, 99d, and 99e have the function of fixing a plurality of drawing positions of the windings 94 such as copper wires, similarly to the above-described guiding part 99a, it becomes possible to improve productivity of the transformer by including the guiding parts 99b, 99c, 99d, and 99e.

Hereinafter, description will be given by taking, as an example, a case where the transformer 91 is a general insulating transformer of a flyback converter.

Since the general insulating transformer of a flyback converter has one winding in a secondary side, both ends of a secondary-side winding (made of a copper wire or the like, for example) in the windings 94 which are wound around the hollow winding drum part 92a are respectively connected to the terminal parts 98a and 98b. At this time, one of both ends is set to pass through the guiding part 99a and the one side of the secondary-side winding is arranged along the guiding part 99a. Though description has been given in the present embodiment for a case where one guiding part 99a is provided in the base part 92b, there is no limitation thereto, and, for example, by providing two guiding parts in the base part 92b and setting both ends of the secondary-side winding to respectively pass through the two guiding parts, both sides of the secondary-side winding may be arranged along the guiding parts. Further, in a case where the insulating transformer of a flyback converter has a sub winding (made of a copper wire or the like, for example) for secondary-side control, by providing four guiding parts in the base part 92b, both sides of the secondary-side winding and both sides of the sub winding for secondary-side control may be arranged along the four guiding parts, respectively.

The general insulating transformer of a flyback converter has, in a primary side, two wirings of a main wiring by which power is stored and transmitted to the secondary side and a sub winding from which power for a power source of a control IC is output. Accordingly, among the windings 94 wound around the hollow winding drum part 92a, both ends of the primary-side main winding (made of a copper wire or the like, for example) and both ends of the primary-side sub winding (made of a copper wire or the like, for example) are respectively connected to the four terminal parts 98c, 98d, 98e, and 98f in the base part 92c. For example, one end of the sub winding is soldered and connected to the terminal part 98e via the guiding part 99e, and the other end of the sub winding is soldered and connected to the terminal part 98f via the guiding part 99b. Similarly, one end of the main winding is soldered and connected to the terminal part 98d via the guiding part 99d, and the other end of the main winding is soldered and connected to the terminal part 98c via the guiding part 99c. Note that, though description has been given in the present embodiment by taking, as an example, a case where the four guiding parts 99b, 99c, 99d, and 99e are provided in the base part 92c, there is no limitation thereto, and, for example, three guiding parts may be provided in the base part 92c and only three ends among those of the primary-side main winding and the primary-side sub winding may be arranged along the guiding parts.

Note that, though the guiding parts 99a, 99b, 99c, 99d, and 99e are formed by notching the base parts in the present embodiment, there is no limitation thereto, and the guiding parts 99a, 99b, 99c, 99d, and 99e may be formed by a method other than this. In addition, it is needless to say that positions, the number, and shapes of the guiding parts 99a, 99b, 99c, 99d, and 99e illustrated in FIG. 14 are able to be changed as appropriate.

Though description has been given in Embodiments 1 to 13 described above by taking, as examples, the PQ-type cores or the RM-type cores, there is no limitation thereto, and a type of cores may be an EPC type which is a horizontal type, for example.

Note that, though description has been given in Embodiments 1 to 6 described above by taking, as examples, a case where the core part has either primary-side potential or secondary-side potential, there is no limitation thereto, and the core part may be in a floating state. In such a case, since it is necessary to secure a predetermined insulation distance from exposed core portions for each of terminal parts in an input side (primary side) and terminal parts in an output side (secondary side), notches may be provided as appropriate.

Moreover, the guiding parts are formed by notching the base parts in the present embodiment, but may have a structure in which holes are provided in the base parts. By arranging windings through such guiding holes, it becomes possible to stabilize soldering work.

### SUMMARY

A transformer in an aspect 1 of the invention is a transformer, including: a bobbin body in which a base and a hollow winding drum provided on the base are integrated; and a first core and a second core which are separately inserted into both ends of a hollow hole of the winding drum so as to hold the base therebetween, in which a first opening portion through which the base extends to an outside of one side of a core part which is formed by stacking the first core and the second core is formed in the first core and the second core, and a notched part which is closer to one region of a first region and a second region in each of which an end part of the base and the first opening portion intersect is formed in a portion of the base, which extends from the first opening portion.

According to the aforementioned configuration, the notched part which is closer to one region of the first region and the second region in each of which the end part of the base and the first opening portion intersect is formed in the portion of the base, which extends from the first opening portion.

With existence of the notched part, it is possible to realize size reduction of the transformer.

Moreover, it is possible to spatially secure insulation characteristics by the notched part of the base, so that it is possible to shorten a length of the base compared with a case where the insulation characteristics are secured only by the base, and it is possible to freely form a shape of the base compared with the case where the insulation characteristics are secured only by the base part.

Thus, according to the aforementioned configuration, it is possible to realize a transformer which secures an insulation property and is capable of further size reduction.

In a transformer of an aspect 2 of the invention, it is preferable that a second opening portion through which the base extends to an outside of the other side of the core part, which is opposite to the one side, is formed in the first core and the second core, and a portion of the base, which extends from the second opening portion, is formed asymmetrically with respect to a line which passes through in between a third region and a fourth region in each of which the end part of the base and the second opening portion intersect.

According to the aforementioned configuration, since the portion of the base, which extends from the second opening portion, is formed asymmetrically, it is possible to suppress interference of the portion of the base, which extends from the second opening portion, with other members.

Thus, it is possible to realize a transformer which secures an insulation property and is capable of further size reduction.

In a transformer of an aspect 3 of the invention, a terminal part is formed in the portion of the base, which extends from the first opening portion.

According to the aforementioned configuration, since there is a notched portion in the base, it is possible to comparatively easily secure insulation characteristics of the terminal part.

In a transformer of an aspect 4 of the invention, it is preferable that the terminal part is formed so as to be distant from one region of the first region and the second region, which is farther from the notched part, by a predetermined distance or more.

According to the aforementioned configuration, since there is a notched portion in the base, the terminal part only needs to be formed so as to be distant from one region of the first region and the second region, which is farther from the notched part, by the predetermined distance or more, so that it is possible to comparatively easily secure the insulation characteristics of the terminal parts.

In a transformer of an aspect 5 of the invention, it is preferable that the base is provided with a guiding part by which a winding wound around the winding drum is drawn to a surface of the base, which is opposite to a surface on which the winding drum is formed.

According to the aforementioned configuration, since it is possible to fix a drawing position of the winding by the guiding part, it is possible to improve productivity of the transformer.

A power source device in an aspect 6 of the invention includes the aforementioned transformer.

According to the aforementioned configuration, since the aforementioned transformer is included, it is possible to realize a power source device which secures an insulation property and is capable of further size reduction.

It is preferable that a power source device of an aspect 7 of the invention includes a housing, in which the portion of the base provided in the transformer, which extends from the first opening portion, extends along an inner wall of the housing.

According to the aforementioned configuration, it is possible to realize a power source device which secures an insulation property and is capable of further size reduction.

It is preferable that a power source device of an aspect 8 of the invention includes a housing, in which the portion of the base provided in the transformer, which extends from the first opening portion, is formed so as to be substantially perpendicular to a part of an inner wall of the housing in a direction from a region including the notched part to a region not including the notched part.

According to the aforementioned configuration, it is possible to realize a power source device which secures an insulation property and is capable of further size reduction.

It is preferable that a power source device of an aspect 9 of the invention includes: the housing an aspect ratio of a longitudinal size and a lateral size of which is equal to or more than 1:3; and a core part which has six side surfaces other than a side surface in which the first opening portion is formed and a side surface opposite to the side surface in which the first opening portion is formed.

According to the aforementioned configuration, it is possible to realize a power source device having a long and thin shape, which secures an insulation property and is capable of further size reduction.

It is preferable that a power source device of an aspect 10 of the invention includes: the housing an aspect ratio of a longitudinal size and a lateral size of which is equal to or less than 1:3; and a core part which has two opposite side surfaces other than a side surface in which the first opening portion is formed and a side surface opposite to the side surface in which the first opening portion is formed.

According to the aforementioned configuration, it is possible to realize a power source device having a matchbox shape, which secures an insulation property and is capable of further size reduction, for example.

In a transformer of an aspect 11 of the invention, it is preferable that the terminal part is formed so that a creepage distance on the base from one region of the first region and the second region, which is farther from the notched part, is equal to or more than a predetermined value.

According to the aforementioned configuration, it is possible to comparatively easily secure insulation characteristics of the terminal part.

In a transformer of an aspect 12 of the invention, it is preferable that the terminal part is formed so that a clearance from one region of the first region and the second region, which is closer to the notched part, is equal to or more than a predetermined value.

According to the aforementioned configuration, it is possible to comparatively easily secure insulation characteristics of the terminal part.

In a transformer of an aspect 13 of the invention, it is preferable that a notched part which is closer to one region of the third region and the fourth region is formed in the portion of the base, which extends from the second opening portion.

According to the aforementioned configuration, it is possible to realize a transformer which secures an insulation property and is capable of further size reduction.

In a transformer of an aspect 14 of the invention, it is preferable that a terminal part is formed in the portion of the base, which extends from the second opening portion.

According to the aforementioned configuration, since there is a notched portion in the base, it is possible to comparatively easily secure insulation characteristics of the terminal part.

In a power source device of an aspect 15 of the invention, it is preferable that the portion of the base provided in the transformer, which extends from the first opening portion or/and the portion of the base, which extends from the second opening portion is/are formed in a shape which goes along one surface of a housing of the power source device.

According to the aforementioned configuration, it is possible to realize a power source device which secures an insulation property and is capable of further size reduction.

A transformer of an aspect 16 of the invention may have a configuration in which the hollow hole of the winding drum extends in an up-and-down direction, and the first core and the second core are separately inserted from the up-and-down direction.

According to the aforementioned configuration, it is possible to realize a vertical transformer which secures an insulation property and is capable of further size reduction.

A transformer of an aspect 17 of the invention may have a configuration in which the hollow hole of the winding drum extends in a right-and-left direction, and the first core and the second core are separately inserted from the right-and-left direction.

According to the aforementioned configuration, it is possible to realize a horizontal transformer which secures an insulation property and is capable of further size reduction.

Note that, the invention is not limited to each of the embodiments described above, and may be modified in various manners within the scope of the claims and an embodiment achieved by appropriately combining technical means disclosed in each of different embodiments is also encompassed in the technical scope of the invention.

### INDUSTRIAL APPLICABILITY

The invention is able to be suitably used for a transformer and a power source device including the transformer.

### REFERENCE SIGNS LIST

1 transformer
2 bobbin body
2a hollow winding drum part (winding drum and base)
2b base part (base)
2c base part (base)
3a terminal part
3b terminal part
4 winding
5 first core
5a opening portion (first opening portion, second opening portion)
6 second core
6a opening portion (first opening portion, second opening portion)
11 transformer
12 bobbin body
12a hollow winding drum part (winding drum and base)
12b base part (base)
13a terminal part (base)
14 winding
15 first core
15a opening portion (first opening portion, second opening portion)
16 second core
16a opening portion (first opening portion, second opening portion)
21 transformer
22 bobbin body
22a hollow winding drum part (winding drum and base)
22b base part (base)
22c base part (base)
23a terminal part
23b terminal part
24 winding
25 first core
25a opening portion (first opening portion, second opening portion)
26 second core
26a opening portion (first opening portion, second opening portion)
31 transformer
32 bobbin body
32a hollow winding drum part (winding drum and base)
32b base part (base)
32c base part (base)
33a terminal part
33b terminal part
34 winding
35 first core
35a opening portion (first opening portion, second opening portion)
36 second core
36a opening portion (first opening portion, second opening portion)
41 adaptor (power source device)
51 transformer
52 bobbin body
52a hollow winding drum part (winding drum and base)
52b base part (base)
53a terminal part
54 winding
55 first core
55a opening portion
56 second core
56a opening portion (first opening portion, second opening portion)
61 transformer
62 bobbin body
62a hollow winding drum part (winding drum and base)
62b base part (base)
62c base part (base)
63a terminal part
63b terminal part
64 winding
65 first core
65a opening portion (first opening portion, second opening portion)
66 second core
66a opening portion (first opening portion, second opening portion)
71 transformer
71a, 71b base part (base)
71c, 71d terminal part
72 adaptor (power source device)
73 transformer
73a, 73b base part (base)
73c, 73d terminal part
74 adaptor (power source device)
75 transformer
75a, 75b base part (base)
75c, 75d terminal part
76 adaptor (power source device)
77 transformer
77a, 77b base part (base)
77c, 77d terminal part
78 adaptor (power source device)
79 transformer
79a, 79b base part (base)
79c, 79d terminal part
80 adaptor (power source device)
81 transformer
81a, 81b base part (base)
81c, 81d terminal part
82 adaptor (power source device)
91 transformer
92 bobbin body
92a hollow winding drum part (winding drum and base)
92b base part (base)
92c base part (base)
94 winding
95 first core
98a terminal part
98b terminal part
98c terminal part
98d terminal part
98e terminal part
98f terminal part
99a guiding part
99b guiding part
99c guiding part
99d guiding part
99e guiding part
exposed core portion A exposed core portion (first region or third region)
exposed core portion B exposed core portion (second region or fourth region)
exposed core portion C exposed core portion (third region or first region)
exposed core portion D exposed core portion (fourth region or second region)

1. A transformer, comprising:
a bobbin body in which a base and a hollow winding drum provided on the base are integrated; and
a first core and a second core which are separately inserted into both ends of a hollow hole of the winding drum so as to hold the base therebetween, wherein
a first opening portion through which the base extends to an outside of one side of a core part which is formed by stacking the first core and the second core is formed in the first core and the second core, and
a notched part which is closer to one region of a first region and a second region in each of which an end part of the base and the first opening portion intersect is formed in a portion of the base, which extends from the first opening portion.

2. The transformer according to claim 1, wherein
a second opening portion through which the base extends to an outside of the other side of the core part, which is opposite to the one side, is formed in the first core and the second core, and
a portion of the base, which extends from the second opening portion, is formed asymmetrically with respect to a line which passes through in between a third region and a fourth region in each of which the end part of the base and the second opening portion intersect.

3. The transformer according to claim 1, wherein a terminal part is formed in the portion of the base, which extends from the first opening portion.

4. The transformer according to claim 3, wherein the terminal part is formed so as to be distant from one region of the first region and the second region, which is farther from the notched part, by a predetermined distance or more.

5. The transformer according to claim 1, wherein the base is provided with a guiding part by which a winding wound around the winding drum is drawn to a surface of the base, which is opposite to a surface on which the winding drum is formed.

6. A power source device, comprising the transformer according to claim 1.

7. A power source device, comprising
a housing, wherein
the portion of the base provided in the transformer according to claim 1, which extends from the first opening portion, extends along an inner wall of the housing.

8. A power source device, comprising
a housing, wherein
the portion of the base provided in the transformer according to claim 1, which extends from the first opening portion, is formed so as to be substantially perpendicular to a part of an inner wall of the housing in a direction from a region including the notched part to a region not including the notched part.

9. The power source device according to claim 6, comprising: the housing, an aspect ratio of a longitudinal size and a lateral size of which is equal to or more than 1:3; and a core part which has six side surfaces other than a side surface in which the first opening portion is formed and a side surface opposite to the side surface in which the first opening portion is formed.

10. The power source device according to claim 6, comprising: the housing, an aspect ratio of a longitudinal size and a lateral size of which is equal to or less than 1:3; and a core part which has two opposite side surfaces other than a side surface in which the first opening portion is formed and a side surface opposite to the side surface in which the first opening portion is formed.
